(19) United States
(12) Patent Application Publication
(10) Pub. No.: US 2020/0103537 A1
(43) Pub. Date: Apr. 2, 2020

(54) SWITCHABLE RADIATION SOURCES AND ACTIVE INTERROGATION METHODS

(71) Applicants: Hyoung K. Lee, Rolla, MO (US); Kyle Paaren, Idaho Falls, ID (US)

(72) Inventors: Hyoung K. Lee, Rolla, MO (US); Kyle Paaren, Idaho Falls, ID (US)

(73) Assignee: The Curators of the University of Missouri, Columbia, MO (US)

(21) Appl. No.: 16/685,499

(22) Filed: Nov. 15, 2019

Related U.S. Application Data
(63) Continuation-in-part of application No. 16/027,632, filed on Jul. 5, 2018.
(60) Provisional application No. 62/529,583, filed on Jul. 7, 2017.

(51) Int. Cl. G01T 1/28

(52) U.S. Cl. CPC G01T 1/28

(57) ABSTRACT

A system for detecting gamma radiation by neutron activation of a material includes a switchable radiation source and at least a first detector. The switchable radiation source includes a primary source assembly having an alpha particle emitter, and a target assembly in which, upon irradiation of the target assembly by alpha particles from the primary source assembly, secondary radiation comprising neutrons is produced. An alignment, proximity or exposure of the primary source assembly relative to the target assembly is adjustable to control irradiation of the target assembly by the primary source assembly and thereby selectively irradiate a material under interrogation with the secondary radiation. The first detector is configured to detect gamma radiation prompted by neutron activation of the material under interrogation.

### CROSS-REFERENCE TO RELATED APPLICATION

This application is a continuation-in-part (CIP), and claims the benefit of priority, of U.S. non-provisional utility patent application Ser. No. 16/027,632, titled “SWITCHABLE RADIATION SOURCES,” filed Jul. 5, 2018. This application, by way of the co-pending Ser. No. 16/027,632 application, claims the benefit of priority of U.S. provisional patent application No. 62/529,583, titled “SWITCHABLE RADIATION SOURCE,” filed on Jul. 7, 2017. The above-referenced applications are incorporated herein in their entireties by this reference.

### TECHNICAL FIELD

The present disclosure relates to radiation or radioisotope production. More particularly, the present disclosure relates to secondary radiation or radioisotope production controlled by adjusting alignment, proximity or exposure of a primary source to a target.

### BACKGROUND

Emissions of natural radioactive isotopes occur with decay time and emitted radiation dictated by nuclear species. Many uses have been found for natural radioactive sources. Secondary radiation or radioisotopes can be produced when primary radiations by a natural source cause reactions or excited state populations in nuclei in a target. A great variety of radiation types characterized by emission type, time properties, and energy would be available if primary sources could be controllably paired with target materials.

Detecting fissionable and other dangerous chemical materials, inside well-constructed containers designed to subvert detection, has been a technical challenge for the national security apparatus and National Nuclear Security Administration (NNSA). Current methods used for detecting fissile material rely off passive and active interrogation. For chemical materials, passive detection is not an option and can only be identified using active interrogation or destructive testing. Passive detection relies on emitted radiation from the material in question, and the secondary radiation that material produces. Active interrogation includes many methods for determining material contents hidden inside of packages. For active neutron interrogation, fast neutrons are pulsed into the contents in question to measure the delayed neutron production and the associated delayed gamma spectrum. The active interrogation of pulsed neutrons lasts 100-900 seconds depending on geometry, distance, and amount of spent nuclear material (SNM) present assuming the neutron source strength is on the order of 10⁸ n s⁻¹. The number of neutrons needed for interrogation is dependent on the level of associated signal needed. By verifying that neutrons are present when the interrogating neutron beam is turned off, the only conclusion is they are produced through fission and sub-critical multiplication.

Prompt Gamma Neutron Activation Analysis (PGNAA) is another method of active interrogation that utilizes thermal neutrons being pulsed into the area of interest. Thermal neutrons are preferred as the cross sections for (n,p) reactions are orders of magnitude greater than those in the fast neutron spectrum. Neutrons are captured by the material, and these materials emit a prompt gamma specific to each isotope. PGNAA is mainly used for isotope identification for different material compositions, but it can be used for localization if multiple detectors are used. This concept can be extrapolated to detect fissionable material using the same methods. Except it utilizes fast neutrons to penetrate shield or moderating materials, which in turn slow the neutrons down for a larger gamma production rate from (n,p) reactions. (n,p) reactions that occur within neutron and gamma shielding materials will be identified as well, in most instances suggesting fissionable material is present.

Detecting special nuclear material that will potentially cross into the border of the United States, remains a high priority for the defense establishment. Ports of entry monitor and scan all arriving packages that will be dispersed throughout the country. The techniques that the government deploys rely on radiation portal monitors and radiation isotope devices. There are also vehicle scanning systems that can be used to determine the existence of contraband explosive materials.

When detecting nuclear material, there are two main strategies. One is passive interrogation, and this type of analysis relies upon a source emitting gamma radiation that directly impinges on a detector system. This is then used to trigger a response in the alarm systems at a port of entry if the associated signal is strong enough. Active interrogation, on the other hand, is the primary technique to determine if there is nuclear weapon material present in the container. This is usually done by interrogating a container with a ²⁵²Cf source to induce a secondary response from the material in question which impinges on a detector system. This can also be done with neutron generators such as deuterium-tritium interactions. ²⁵²Cf is a useful isotope for such use since it undergoes spontaneous fission and does not rely on electrical inputs. However, both techniques suffer when there is a well-constructed shielding apparatus around the material. For neutrons, the shield can be constructed from materials with high hydrogen contents, and for gammas, the shield can be constructed with materials of high effective proton numbers. One way to combat well-constructed shielding, that would reduce signal to undetectable levels, would be to increase the sensitivity of the detector system. However, this yields more false positives which can slow traffic at ports of entry. Thus, improvements are needed to determine not only if special nuclear material (SNM) is present, but where it is located within a container volume.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a system for detecting gamma radiation by neutron activation of a material includes a switchable radiation source and at least a first detector. The switchable radiation source includes a primary source assembly having an alpha particle emitter, and a target assembly in which, upon irradiation of the target assembly by alpha particles from the primary source assembly, secondary radiation comprising neutrons is produced. An alignment, proximity or exposure of the primary source assembly relative to the target assembly is adjustable to control irradiation of the target assembly by the primary source assembly and thereby selectively irradiate a material under interrogation with the secondary radiation. The first detector is configured to detect gamma radiation prompted by neutron activation of the material under interrogation.

In at least one example, the target assembly includes a stable isotope and irradiation of the target assembly by alpha particles from the primary source assembly creates compound nuclei and neutrons.

The primary source assembly may include at least one planar source tile, the target assembly may include at least one planar target tile, and alignment or proximity of the source tile and target tile may be adjustable by movement of the source tile or target tile.

In at least one example, a shielding shell is movable by rotation or translation between the primary source assembly and target assembly.

The target assembly may include a circular arrangement of multiple target panels, and the primary source assembly include a source panel relative to which the circular arrangement of multiple target panels is rotatable.

The first detector may include a high purity germanium detector.

The first detector may include a lanthanum-bromide detector.

The first detector may include a plastic scintillator.

A shielding material may partially surround the first detector.

The material under interrogation may be positioned in a container, and the switchable radiation source device may be positioned outside of the container.

The first detector may be configured to detect the gamma radiation through the container.

The system may include a second detector configured to detect gamma radiation prompted by neutron activation of the material under interrogation through the container.

The system may be configured to determine a location of the material under interrogation based on signals from the first detector and second detector.

The alpha particle emitter may include americium-241, and the target assembly may include beryllium.

In at least one embodiment, a method for detecting gamma radiation by neutron activation of a material includes: irradiating a target assembly with alpha particles from a primary source assembly, thereby producing secondary radiation comprising neutrons; irradiating a material under interrogation with the secondary radiation; and detecting gamma radiation prompted by neutron activation of the material under interrogation. Irradiating the target assembly with alpha particles from the primary source assembly includes controlling a switchable radiation source in which an alignment, proximity or exposure of the primary source assembly relative to the target assembly is adjustable to control irradiation of the target assembly by the alpha emitter and thereby selectively irradiate a material under interrogation with the secondary radiation.

The primary source assembly may include at least one planar source tile; the target assembly may include at least one planar target tile, and controlling the switchable radiation source may include adjusting alignment or proximity of the source tile and target tile by movement of the source tile or target tile.

Controlling the switchable radiation source may include moving a shielding shell by rotation or translation between the primary source assembly and target assembly.

In at least one example, the target assembly includes a circular arrangement of multiple target panels, the primary source assembly includes a source panel relative to which the circular arrangement of multiple target panels is rotatable, and controlling the switchable radiation source includes selecting an angular position of the target assembly relative to the primary source assembly.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1A is a perspective view of an alpha source according to at least one embodiment.

FIG. 1B is a view of an edge of the alpha source of FIG. 1.

FIG. 1C is an enlarged view of a portion IC as indicated in FIG. 1B of the layered active side of the alpha source of FIG. 1A.

FIG. 2A is an exploded perspective view of a switchable source device according to at least one embodiment.

FIG. 2B is a plan view along the Z-axis of the switchable source device of FIG. 2A in an off state configuration.

FIG. 3 is a plan view along the Z-axis of the switchable source device of FIG. 2A in an on state configuration.

FIG. 4A is a partially exploded perspective view representation of a switchable source device according to at least one other embodiment.

FIG. 4B is a perspective view representation of a switchable source device according to at least one other embodiment.

FIG. 5 is a side view of a switchable source device according to yet another embodiment.

FIG. 6 is a plot, for several isotopes, of the number of initial atoms in calculations with an Am-241 source (1 Ci).

FIG. 7 is a plot of the number of product atoms in the Am-241 (1 Ci, FIG. 6) calculations.

FIG. 8 is a plot of activities of produced foils in the Am-241 (1 Ci, FIG. 6) calculations.

FIG. 9 shows simulated alpha particle paths in penetrating an Au plating and ²⁷Al target

FIG. 10 is a plot of stopping power in Al as a function of particle energy.

FIG. 11 is a plot of stopping power in Au as a function of particle energy.

FIG. 12 is a plot of neutron energies for expected neutron production.

FIG. 13A is a plan view of a switchable source device according to at least one embodiment.

FIG. 13B is a perspective view of the switchable source device of FIG. 13A.

FIG. 14 is a plot, for several isotopes, of the number of initial atoms in calculations with an Am-241 source (1 Ci).

FIG. 15 is a plot of the number of product atoms in the Am-241 (1 Ci, FIG. 15) calculations.

FIG. 16 is a plot of activities of produced foils in the Am-241 (1 Ci, FIG. 15) calculations.

FIG. 17 is a plot neutron emission rate from target foils in the Am-241 (1 Ci, FIG. 15) calculations.

FIG. 18 is an MCNP input card (XY) representation of a modeled detection system, as visualized using MCNPX visual editor;

FIG. 19 is a PGNAA spectra for a rear detector array for 256 cm³ of SNM with HPGe detectors and a 10⁸ particle history;

FIG. 20 shows Uranium PGNAA spectra from a rear detector array with HPGe detectors and a 10⁸ particle history;

FIG. 21 shows PGNAA spectra from rear detector arrays using HPGe and LaBr₃ detectors with 256 cm³ of Plutonium and a 10⁸ particle history;

FIG. 22 is a plot of LaBr₃ 61 keV fission Peak-to-Background ratio at varying particle histories, 16 cm³;

FIG. 23 is a plot of HPGe 61 keV fission Peak-to-Background ratio at varying particle histories, 16 cm³;

FIG. 24 is an LaBr₃ peak-to-total ratio plot of the 2.223 MeV prompt gamma from hydrogen at varying particle histories, 16 cm³;

FIG. 25 is an HPGe peak-to-total ratio plot of the prompt gamma from hydrogen at varying particle histories, 16 cm³;

FIG. 26 is a plot of uranium LaBr₃ relative uncertainty of the 2.223 MeV prompt gamma from hydrogen;

FIG. 27 is a plot of plutonium HPG3 relative uncertainty of the 2.223 MeV prompt gamma from hydrogen;

FIG. 28 is an MCNP input card representation of a detection system, according to at least one embodiment, with HPGe and LaBr₃ Detectors XY plane, Z=0;

FIG. 29 is an MCNP input card representation of a detection system, according to at least one embodiment, with BC-408 Detectors XY plane, Z=0;

FIG. 30 is a plot of PGNAA detector response from SNM;

FIG. 31 is a plot of neutron BC-408 scintillator detector response from SNM; and

FIG. 32 is a representation of an MCNP Input card secondary source location XY plane, Z=−9.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

For the sake of brevity, the following abbreviations may be used in these descriptions:
MCNP—Monte-Carlo N-Particle transport
SNM—Special Nuclear Material
PGNAA—Prompt Gamma Neutron Activation Analysis
HEU—High Enriched Uranium
nTOF—neutron Time Of Flight
NNSA—National Nuclear Security Agency
WGPu—Weapons Grade Plutonium
HPGe—High Purity Germanium
LaBr₃— Lanthanum-Bromide
FWHM—Full Width at Half Maximum

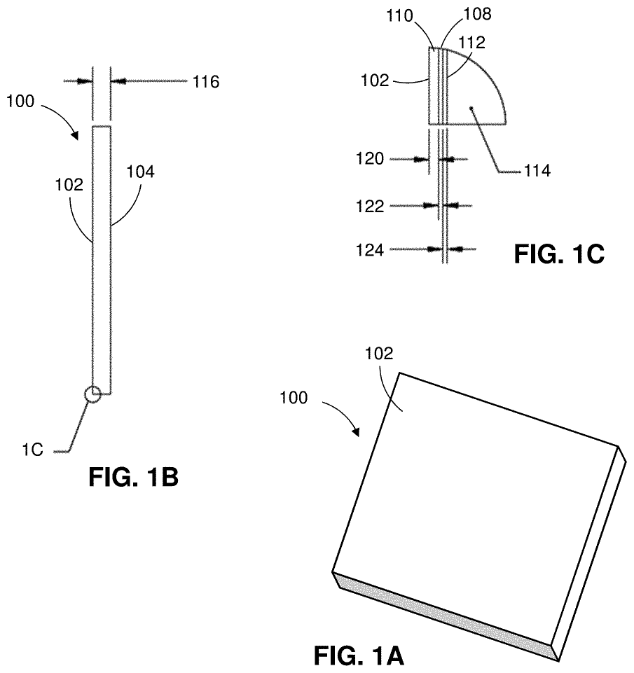

The following section describes, with reference to FIGS. 1-17, switchable radiation sources. In at least one embodiment, Alpha-capture reactions are used in source generation applications. A reaction is produced by having an alpha emitting isotope bombard a stable isotope, creating a compound nucleus between an alpha particle and the target nucleus. The compound nucleus will be in an excited state, and emit gammas, neutrons, and or protons depending on the target material. Target materials are specifically chosen that will emit the desired type of radiation after alpha-capture; the energy of the radiation may also vary by changing the target material. The amount of each type of radiation produced depends on the energy of the alpha particle and the target material. A thin sheet of non-metallic shielding material may be used to screen or block alpha particles from hitting the target, thus acting as an attenuator or a switch for the source generator. The non-metallic material may be moved by an actuator operated by or switched according to an electric signal.

The device may be scaled to allow for different intensities of radiation. Increasing the activity of the alpha source will result in more radiation produced by the target material through alpha-capture reactions.

These descriptions detail an approach to experimental validation of previous alpha-capture cross section values and comparison to the analytical values approximated by using Hauser-Feshbach calculations. These values are then compared to analytical validated cross sections found in the NON-SMOKER database, which contains statistical model results for a range of nuclei. These cross sections are dependent on the energy of the alpha particle. This energy will vary due to different alpha sources being used. The activity of the alpha source will depend on the geometry used and the alpha flux needed for irradiation. Due to the alpha-capture cross section of the target materials being energy dependent on the alpha particle, reaction rates will be calculated for each independent source. The energy of the gammas, neutrons, and protons are dependent on the energy of the alpha particle, binding energy of the stable target, and electron structure of the stable target.

Alpha-capture cross sections for X(α,γ)Y are evaluated experimentally using multiple alpha sources and foil targets. The different alpha sources and materials are listed in Table 1. An alpha source geometry example is provided in FIG. 1. The solid angle, and nuclear forces between the alpha particle and target nucleus were considered in calculations. Experimentally measured cross sections will then be compared to NON-SMOKER database and analytically calculated values. Analytical alpha-capture cross sections were estimated using Equation 1. Variables used in Equation 1 are found in the Nomenclature Listing below and were calculated using equations from J. M. Blatt, Theoretical Nuclear Physics, New York: Springer-Verlag, 1979.

Within Equation 1, compound nucleus values are used to analytically obtain the capture cross section. The summation occurs over the angular momentum values of the alpha particle, ranging from zero to n, which is the maximum angular momentum quantum number. The change in angular momentum, denoted as Δl, of the alpha particle from the ground state. The intrinsic spin of the alpha particle, denoted by sₗ, interacting with the target nucleus as the angular momentum changes through the summation, which is constant. The wavelength of the alpha particle is λ. The wave number just after the alpha particle enters the target nucleus is K. The compound nucleus radius of the alpha particle and the target is R. R and K remain constant throughout the summation. Equation 1 is generally true for any target atom, but has been used specifically for finding alpha-capture cross sections.

The alpha-capture cross section obtained from NON-SMOKER database was used as the microscopic capture cross section in Equation 2 to determine the expected activation of the foil targets. The flux used in Equation 2 varies depending on the activity of the alpha sources. The decay constant in Equation 2 is the decay constant of the newly formed compound nucleus after alpha capture, and t is the activation time. Equation 2 was integrated over time to determine the expected counts from alpha-activation. Using an activation time of 24 hours, the integral of Equation 2 predicts the number of counts emitted from the reaction.

$$\begin{matrix}{σ}_{C} ( α ) = π {λ}^{2} {\sum }_{l = 0}^{n} ( 2 l + 1 ) \frac{4 {s}_{l} KR}{{( Δ l )}^{2} + {( KR + {s}_{l} )}^{2}} & ( Equation 1 ) \\ {A}_{t} = \frac{{amN}_{a}}{AW} {σ}_{c} φ ( 1 - {e}^{- Λ t} ) & ( Equation 2 )\end{matrix}$$

Experimental Cross Sections and Theoretical Yields of Target Materials:

Analytical validation has been done and cross sections have been obtained from the NON-SMOKER database. Values for cross sections for multiple proposed foil target materials were found (see Appendix 1 of U.S. Provisional Patent Application 62/529,583).

Alpha Sources and Target Materials:

Multiple isotopes for the alpha source may be implemented based upon the desired emission rates of different particles. The nuclear properties of the alpha sources are listed in Table 1. Alpha particle energies and their half-lives are included in Table 1.

TABLE 1
Alpha source properties

| | Alpha Energy | Half-life |
|---|---|---|
| Alpha | (MeV) | (years) |
| ¹⁴⁸Gd | 3.182 | 71.1 |
| ²¹⁰Po | 5.3044 | 0.379112329 |
| ²²⁶Ra | 4.7844 | 1600 |
| ²²⁸Th | 5.423 | 1.9116 |
| ²²⁹Th | 4.5845 | 7880 |
| ²³¹Pa | 5.013 | 32760 |
| ²³²U | 5.3203 | 68.9 |
| ²³⁶Pu | 5.7675 | 2.858 |
| ²³⁹Pu | 5.156 | 24110 |
| ²⁴⁰Pu | 5.1685 | 6561 |
| ²⁴¹Am | 5.4857 | 432.6 |
| ²⁴³Am | 5.276 | 7364 |
| ²⁴²Cm | 6.1127 | 0.446027397 |
| ²⁴³Cm | 5.785 | 29.1 |
| ²⁴⁴Cm | 5.8048 | 18.1 |
| ²⁴⁵Cm | 5.362 | 8423 |
| ²⁴⁶Cm | 5.386 | 4706 |
| ²⁴⁷Cm | 4.87 | 15600000 |
| ²⁴⁸Cm | 5.078 | 348000 |
| ²⁴⁹Cf | 5.813 | 351 |
| ²⁵⁰Cf | 6.0304 | 13.08 |
| ²⁵⁴Es | 6.429 | 0.755342466 |

Target materials were chosen specifically for their transmutation products after absorbing an alpha particle. Equation 3 demonstrates an X(α,γ)W reaction, Equation 4 demonstrates an X(α,n)W reaction, and Equation 5 demonstrates an X(α,p)W reaction. Table 2 lists the Initial material and the products produced. Table 3 and Table 4 contain nuclear properties of the target materials and the corresponding products.

α+_{y}^{z}X→_{y+2}^{z+4}W+γ (Equation 3)

α+_{y}^{z}X→_{y+2}^{z+3}W+n (Equation 4)

α+_{y}^{z}X→_{y+1}^{z+3}W+p (Equation 5)

In Equation 3, α is the alpha particle, γ is the atomic number of the target material, z is the atomic mass of the target material, and γ is the photon emission from the reaction. X is the target material and W is the product of X after transmutation.

TABLE 2
Target materials and corresponding products

| Target | Product | Product | Product |
|---|---|---|---|
| (X) | (α, γ) | (α, n) | (α, p) |
| ³⁹K | ⁴³Sc | ⁴²Sc | ⁴²Ca |
| ⁴⁰K | ⁴⁴Sc | ⁴³Sc | ⁴³Ca |
| ⁴⁰Ca | ⁴⁴Ti | ⁴³Ti | ⁴³Sc |
| ⁴⁷Ti | ⁵¹Cr | ⁵⁰Cr | ⁵⁰V |
| ⁵⁸Ni | ⁶²Zn | ⁶¹Zn | ⁶¹Cu |
| ⁶³Cu | ⁶⁷Ga | ⁶⁶Ga | ⁶⁶Zn |
| ⁷⁹Br | ⁸³Rb | ⁸²Rb | ⁸²Kr |
| ⁴⁸Ca | ⁵²Ti | ⁵¹Ti | ⁵¹Sc |

TABLE 3
Target material properties

| Target | | atomic |
|---|---|---|
| (X) | abundance | weight |
| ³⁹K | 0.932581 | 38.96370649 |
| ⁴⁰K | 0.9 | 39.96399817 |
| ⁴⁰Ca | 0.96941 | 39.9626 |
| ⁴⁷Ti | 0.0744 | 46.95175879 |
| ⁵⁸Ni | 0.680769 | 57.93534241 |
| ⁶³Cu | 0.6915 | 62.92959772 |
| ⁷⁹Br | 0.5069 | 78.91833758 |
| ⁴⁸Ca | 0.00187 | 47.95252277 |

TABLE 4
Product nuclear properties

| | | Decay Constant | gamma energy | emission |
|---|---|---|---|---|
| Product (W) | Half-life (s) | (s⁻¹) | (keV) | rate |
| ⁴²Sc | 0.6813 | 1.02E+00 | 1524 | 0.000075 |
| ⁴³Sc | 14007.6 | 4.95E−05 | 372.9 | 0.225 |
| ⁴⁴Sc | 14292 | 4.85E−05 | 1157 | 0.999 |
| ⁵¹Sc | 12.4 | 5.59E−02 | 1437.3 | 0.52 |
| ⁴²Ca | stable | 0 | N/A | N/A |
| ⁴³Ca | stable | 0 | N/A | N/A |
| ⁴⁴Ti | 1.87E+09 | 3.71E−10 | 78.3 | 0.964 |
| ⁵¹Ti | 345.6 | 2.01E−03 | 320.076 | 0.93 |
| ⁵²Ti | 102 | 6.80E−03 | 124.45 | 0.917 |
| ⁵³Ti | 0.509 | 1.36E+00 | 2288 | 0.044 |
| ⁵⁰V | stable | 0 | N/A | N/A |
| ⁵⁰Cr | stable | 0 | N/A | N/A |
| ⁵¹Cr | 2.39E+06 | 2.90E−07 | 320 | 0.09 |
| ⁶¹Cu | 12020.4 | 5.77E−05 | 282.956 | 0.122 |
| ⁶¹Zn | 89.1 | 7.78E−03 | 475 | 0.165 |
| ⁶²Zn | 33192 | 2.09E−05 | 596 | 0.26 |
| ⁶⁶Zn | stable | 0 | N/A | N/A |
| ⁶⁶Ga | 34164 | 2.03E−05 | 1039 | 0.37 |
| ⁶⁷Ga | 281759.04 | 2.46E−06 | 93, 184, 300 | 0.38 |
| ⁸²Kr | stable | 0 | N/A | N/A |
| ⁸²Rb | 75.45 | 9.19E−03 | 776.5 | 0.1508 |
| ⁸³Rb | 7.45E+06 | 9.31E−08 | 520 | 0.45 |

Device Geometry:

A switchable radioisotope source device can utilize alpha particles to irradiate stable target materials to emit photons, neutrons, and or protons. Depending on the need of the consumer and the application, the size and strength of the switchable isotope source device may be changed. The probability of producing each particle and product may be found in the preceding under Experimental Cross Sections and Theoretical Yields of Target Materials and in Appendix 1 of U.S. Provisional Patent Application 62/529,583, and are dependent on the alpha particle energy. Specific activities of the produced products may be between 1000 and 10000 Bq/g.

FIG. 1A is a perspective view of a layered alpha source assembly 100 according to at least one embodiment. FIG. 1B is a view of an edge of the alpha source of FIG. 1. The alpha source assembly 100 is shown as a panel or generally planar construction having a forward active side 102 and a rear inactive side 104. The relative and absolute outer dimensions of the alpha source assembly 100 such as length and width can be selected according to use. A square tile geometry is illustrated as one example. Other shapes are within the scope of these descriptions. For example, triangular, hexagonal, and other shapes may be used.

As shown in FIG. 1C, the illustrated layered alpha source assembly 100 has an active matrix 108 between a forward layer 110 and an interface layer 112. This forward laminate assembly, including the forward layer 110, active matrix 108, and interface layer 112 is mounted on a rearward backing 114. The forward layer 110 may be or include Au or Palladium for example. The interface layer 112 may be or include Au for example. The rearward backing 114 may be or include Ag for example.

In at least one example according to FIGS. 1A-1C: the total thickness 116 of the layered alpha source assembly 100 is in a range of approximately 0.15 millimeters to 0.25 millimeters; the thickness 120 of the forward layer 110 is approximately 0.002 millimeter; the thickness 122 of the active matrix 108 is approximately 0.002 millimeter; the thickness 124 of the interface layer 112 is approximately 0.001 millimeter; and the thickness of the backing 114 accounts for the remainder of the total thickness 116. All materials and dimensions are provided as non-limiting examples.

Switchable Source Device:

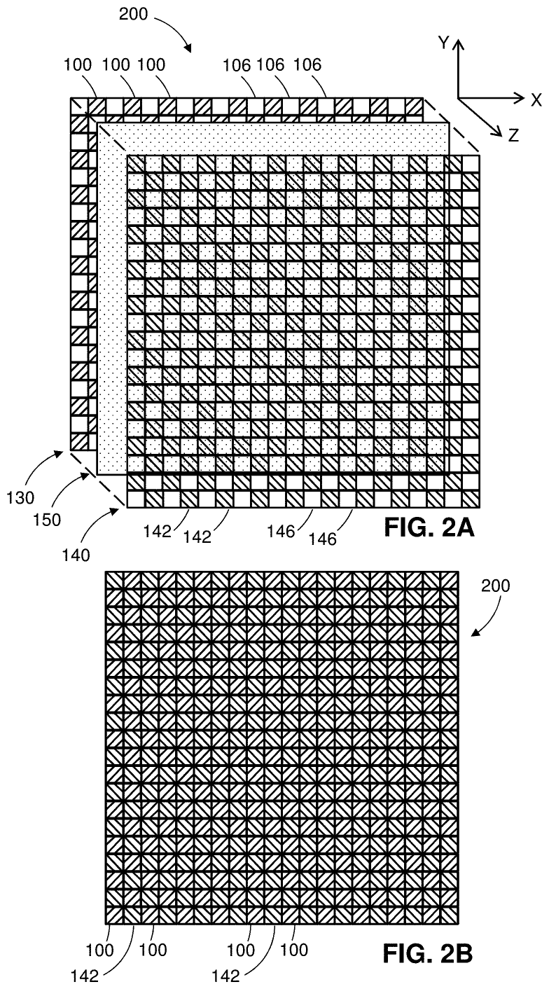

FIG. 2A is an exploded perspective view of a switchable source device 200 according to at least one embodiment. The device 200 includes a rearward patterned source panel 130 that includes source assemblies 100 (see FIG. 1) serving as tiles, represented as patterned cells, in a checkered arrangement extending along X and Y axis directions. In the source panel 130, intermediate inactive spaces or tiles 106, represented as interstitial blank cells, are placed between the separated source assemblies 100. The device 200 includes a forward patterned target panel 140 that includes target tiles 142, represented as patterned cells, separated by unreactive spaces or tiles 146, represented as blank cells. Z-axis spacing of the source panel 130 and target panel 140 may be exaggerated in the drawings to illustrate the layered construction of the switchable source device 200. Dimensions are not necessarily represented to scale. An optional shielding panel 150 is shown in FIG. 2A as positioned between the source panel 130 and target panel 140.

In FIG. 2A, the forward active sides 102 (FIG. 1) of the source assemblies 100 of the patterned source panel 130 face forward toward the target panel 140. The configuration of the switchable source device 200 in FIG. 2A represents an off state of the device 200 with regard to secondary radiation or radioactivity production due to both the position of the intervening shielding panel 150 and the alignment (X-Y) of the source assemblies or tiles 100 with the unreactive spaces or tiles 146 of the target panel 140.

FIG. 2B is a plan view along the Z-axis of the source panel 130 and target panel 140, with the shielding panel 150 either removed or shown as transparent to illustrate the offset or misaligned X-Y positions of the source assembly or tiles 100 with the target tiles 142 of the target panel 140. Thus, in FIG. 2B, primary radiations emitted by the source panel 130 only minimally or peripherally reach the target tiles 142 in the off state of the device 200 and so secondary radiation or radioactivity production is minimized. Primary radiations refer to source or origin radiations at the source panel, and include for example natural radioactive decay. Secondary radiation production refers to induced, produced or otherwise resultant radiation, radioactivity, or radioisotopes that occur as the primary radiations cause reactions or excited state populations in nuclei at the target panel.

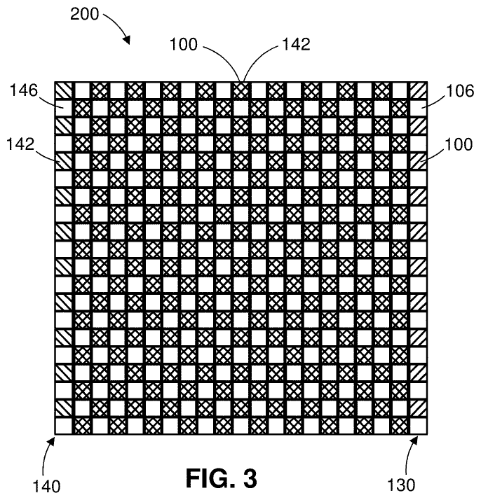

FIG. 3 is a plan view along the Z-axis of the source panel 130 and target panel 140, with the shielding panel 150 either removed or shown as transparent to illustrate aligned X-Y positions of the source assembly 100 tiles with the target tiles 142 of the target panel 140. In particular, the target panel 140 in FIG. 3 is shifted along the X-axis by one cell relative to FIG. 1. The shift brings the X-Y positions of many of the source tiles into alignment with the target tiles as represented by the superimposed cell patterns at coinciding X-Y positions. Thus, in FIG. 3, primary radiations emitted by the source panel 130 optimally and maximally reach the target tiles 142 and so secondary radiation or radioactivity production is maximized. This configuration represents an on state of the switchable source device 200.

While a square tile geometry is illustrated, other shapes that overlap into alignment and stagger out of alignment are within the scope of these descriptions. For example, other rectangular shapes other than squares may be used, and triangular, hexagonal, and other shapes may be used.

In FIGS. 2A, 2B and 3, the checkered pattern allows for the target material to slide over the source material, enabling secondary radiation to be turned on and off. This checkered pattern may be implemented twice to create a solid panel. This concept can also be applied to a single plate and a single target. This geometry may be very small around 1 cm for material identification or as large as several meters for gamma ray or neutron imaging for large scale transportation.

Spherical Source:

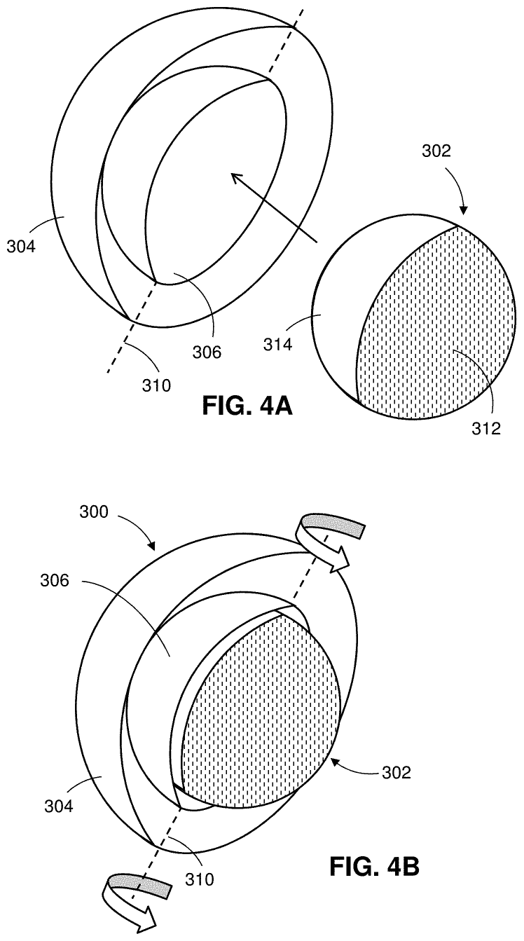

FIG. 4A is a partially exploded perspective view representation of a switchable source device 300 according to at least one other embodiment. The switchable source device 300 is shown assembled in perspective view in FIG. 4B. The switchable source device 300 includes an inner spherical target core 302, an outer source shell 304, and a radially intermediate shielding shell 306. The core 302, source shell 304 and intermediate shielding shell 306 are concentric (FIG. 4B) in the assembled device 300. Each has a full spherical, hemispherical, or partial spherical shape in various embodiments. In the illustrated embodiment, the target core 302 has a spherical form with a first hemisphere 312 (FIG. 4A) that includes a first target material and an opposite second hemisphere 314 that includes a second material, which may be a different target material than the first or may be inert.

In the particularly illustrated design of FIG. 4, the shielding hemisphere 306 rotates around the diametric axis 310, which allows source-target interactions and consequent produced secondary radiations to be turned on and off. The spherical geometry allows for a higher alpha particle flux on the target material and increases emissions, relative to other geometries such as planar examples, by changing the surface area/volume ratio of the target. The size of the spherical design is meant to be within centimeters in at least one embodiment. The material of the shielding shell 306 can be a material that is immune to alpha capture due to the Coulomb force in the nucleus. Non-limiting example materials are gold, tungsten, and rhenium. Containment of the alpha particles is not a concern as they contribute no external dose, but the produced gammas may be collimated to direct the isotropic source.

Plate with Shielding:

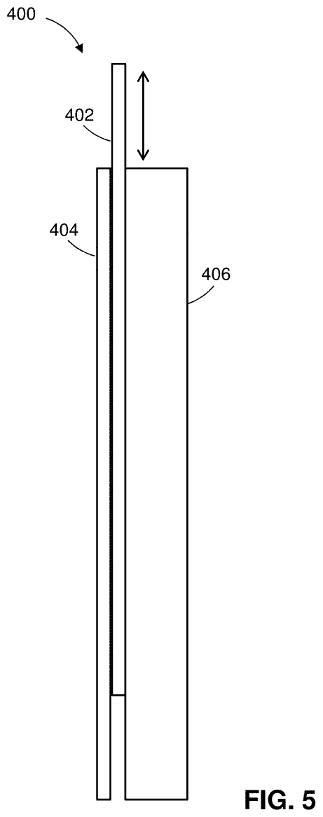

FIG. 5 is a side view of a switchable source device 400 according to yet another embodiment. Produced secondary radiation is controlled by a movable shielding plate 402 between a source panel 404 and a target material panel 406. The shielding may be lowered completely to stop all interactions. The side view of FIG. 5 is shown to better illustrate the geometry since the plates are very long and thin. This geometry may be very small around 1 cm for material identification or as large as several meters for gamma ray or neutron imaging for large scale transportation. The shielding material will be a material that is immune to alpha capture due to the Coulomb force in the nucleus. Such materials include for example gold, tungsten, and rhenium. Containment of the alpha particles is not a concern as they contribute no external dose, but the produced gammas may be collimated to direct the isotropic source.

Expected Activities and Products:

The activities of activated foils were calculated using Mathcad 15 by utilizing coupled differential equations. The alpha-capture cross sections for each of the foil materials were interpolated for an energy of 5.48 MeV. Activities of activated foils were calculated for 1 Ci, 0.1 Ci, and 10 mCi sources of ²⁴¹Am. Based on the results, the activated material for spectroscopy is obtained using a 1 Ci ²⁴¹Am on nickel and copper foil targets. Potassium was disregarded due to it being a very reactive metal. These calculations are to show proof of concept for the switchable radioisotope and are to be used as a template to calculate product activities.

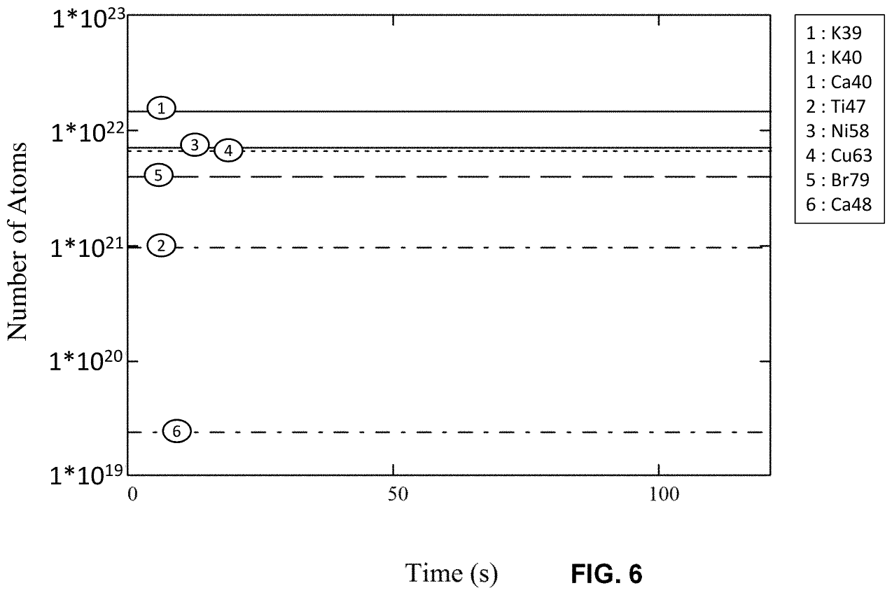

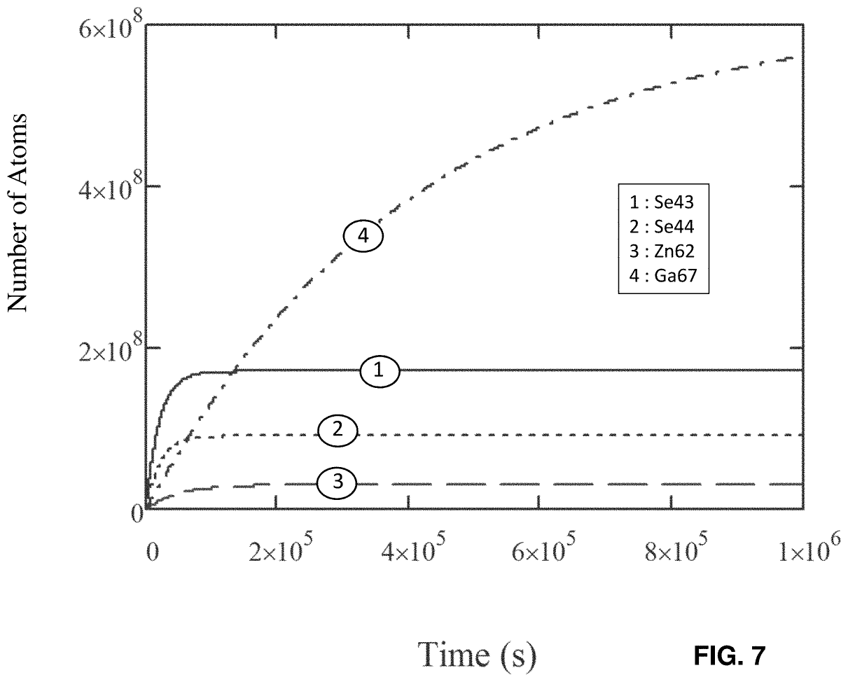

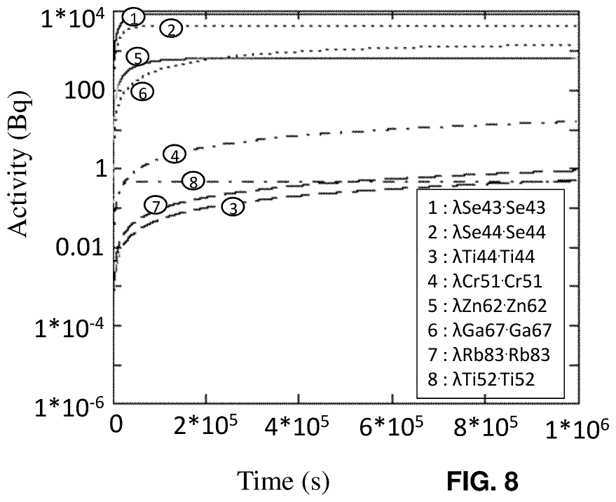

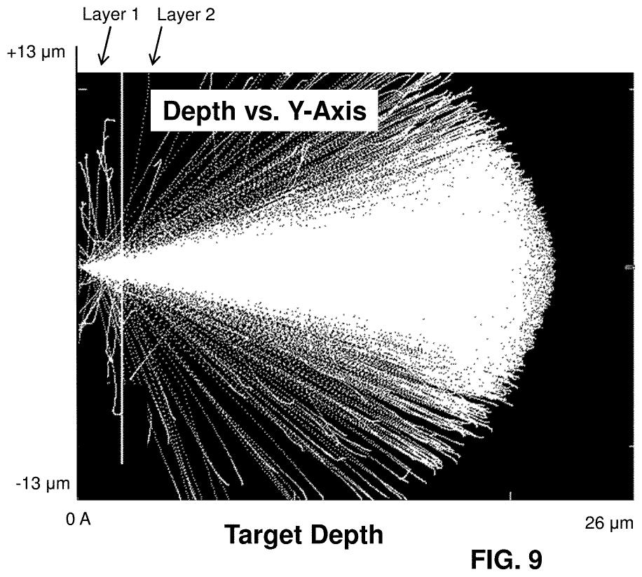

FIG. 6 is a plot, for several isotopes, of the number of initial atoms in calculations with an Am-241 source (1 Ci). FIG. 7 is a plot of the number of product atoms in the Am-241 (1 Ci, FIG. 6) calculations. FIG. 8: is a plot of activities of produced foils in the Am-241 (1 Ci, FIG. 6) calculations.

Similar calculations as those for which the results are shown in FIG. 6-8 (1 Ci Am-241) were performed for a 0.1 Ci ²⁴¹Am source. This reduced the order of magnitude of the activity and flux by one. Similar calculations were also performed for the 10 mCi ²⁴¹Am source. This further reduced the order of magnitude of the activity and flux by one relative to the 0.1 Ci calculations, demonstrating the results varied to scale with source activity. All cross sections and decays were kept the same.

### NOMENCLATURE LISTING

a=isotope abundance
Aₜ=activity
AW=atomic weight
Δl=angular momentum change
Λ=decay constant
λ=alpha particle wavelength
K=Wave number inside target nuclear surface
l=angular momentum of alpha particle
m=mass
n=maximum angular momentum of alpha particle
Nₐ=Avogadro's number
R=compound nuclear radius
sₗ=intrinsic spin of alpha particle
Φ=flux

A reaction in the above or other embodiments as described below is produced by having an alpha emitting isotope bombard a stable isotope, creating a compound nucleus and the ejection of a neutron. Radiations such as gammas and or neutrons are then emitted depending on the target material. Target materials are specifically chosen that will emit the desired type of neutron energy after alpha-capture; the scattering angle of the radiation may also vary by changing the target material. The amount of each type of radiation produced depends on the energy of the alpha particle and the target material. A rotary device may be used to place targets in front of or away from alpha particles, thus acting as a switch for the neutron source generator. The rotary device may be moved through an electric signal or mechanically.

Alpha-capture cross sections for ²⁷Al(α,n)³⁰P are evaluated experimentally using a 90 μCi ²⁴¹Am alpha source and foil targets. The ²⁴¹Am alpha source information is provided in FIGS. 1A-1C. A ³He neutron detector is used to measure (α,n) reactions. The solid angle, detector efficiency, and nuclear forces between the alpha particle and target nucleus were considered in calculations. Experimentally measured cross sections will then be compared to NON-SMOKER database, ENDF, and analytically calculated values.

Cross sections found within ENDF were integrated over energy, then averaged to find the average interaction rate for each material depending on the starting energy of the alpha particle. This may be seen in Equation 6. The averaged cross section obtained from Equation 6 was used as the microscopic capture cross section in Equation 7 to determine the expected activation of the foil targets. The flux used in Equation 7 varies depending on the activity of the ²⁴¹Am source. The decay constant in Equation 7 is the decay constant of the newly formed compound nucleus after alpha capture, and t is the activation time. Equation 7 was integrated over time to determine the expected counts from alpha-activation. Using an activation time of 24 hours, the integral of Equation 7 predicts the number of counts incident on the NaI detector. Equation 8 is used to determine the neutron production rate from the foil and the expected count rate on the ³He neutron detector.

$$\begin{matrix}{σ}_{ave} = \frac{1}{{E}_{α}} {\int }_{0}^{{E}_{α}} σ ( E ) dE & ( Equation 6 ) \\ {A}_{t} = \frac{{amN}_{a}}{AW} {σ}_{ave} φ ( 1 - {e}^{- Λ t} ) & ( Equation 7 ) \\ {A}_{n} = N {σ}_{ave} φ & ( Equation 8 )\end{matrix}$$

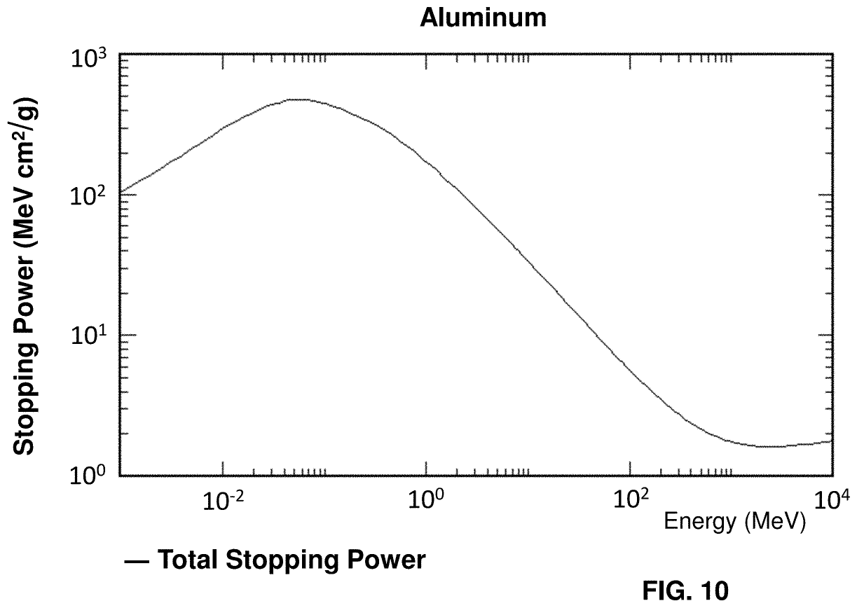

Stopping power charts for each target material was used in combination with Srim & Trim to find the range of alpha particles in various target materials. This allowed the optimal target thickness to be determined. An example of a stopping power chart is provided in FIG. 10.

Expected Neutron Production:

Calculating the neutron production rate for a foil target included the change in alpha energy as it moves through the foil target, secondary energy of the neutrons, angle of scattering, and energy dependent cross sections. Stopping power was used to determine the target thickness for the highest production rate. Simulations in SRIM were run to show the path alpha particles travel as they enter a ²⁷Al target, as seen in FIG. 9. This was done to show an example of the process conducted for all foil targets.

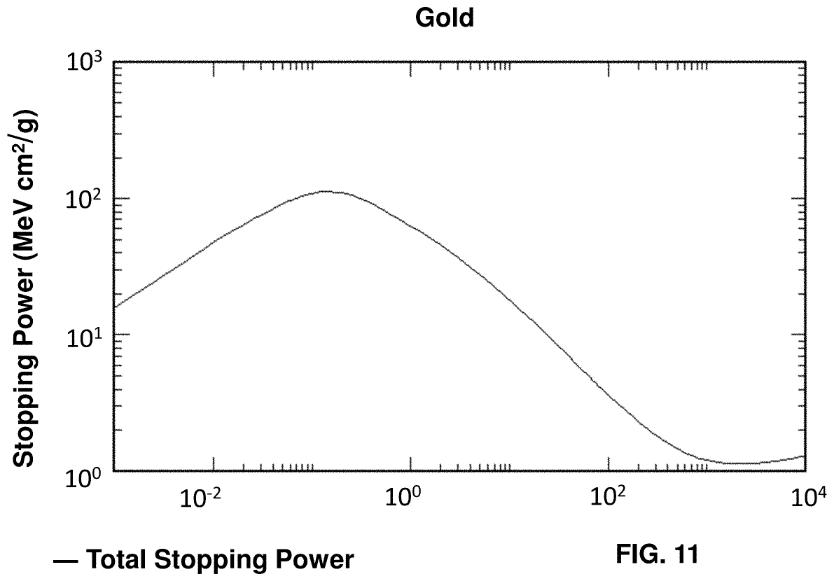

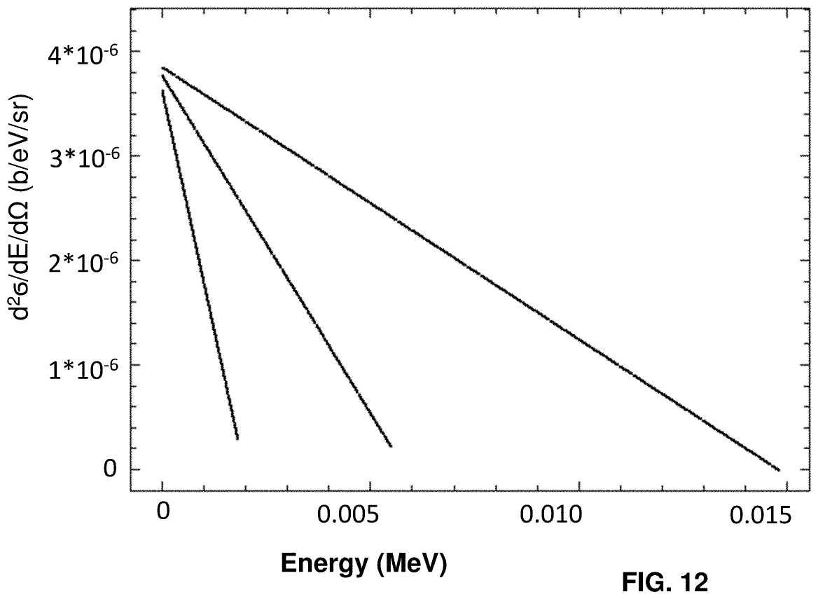

For the simulation, one hundred thousand individual particles were run. Values for ²⁷Al were integrated and averaged to account for the change in energy of the alpha particle as it moves through the ²⁷Al target. Stopping power figures shown in FIGS. 10 and 11 were used to determine the optimal target thickness, which is 25 am. This was used to find the total number of target atoms for ²⁷Al in a 2 cm×2 cm×25 m target foil. The number of target atoms was then multiplied by the energy averaged cross section and the alpha flux from the 90 μCi ²⁴¹Am source. This yields an expected neutron production rate of 5.6 neutrons per second, where the neutron energies may be found in FIG. 12.

Experimental Cross Sections and Theoretical Yields:

Analytical validation has been done and cross sections have been obtained from the ENDF database. Values for cross sections for the proposed foil targets were determined. The cross sections were integrated then averaged to find expected interaction rates used in calculations.

Alpha Sources and Target Materials:

Multiple isotopes for the alpha source may be implemented based upon the desired emission rates of neutrons and their respective energy. The nuclear properties of the alpha sources are listed in Table 1 in the preceding. Alpha particle energies and their half-lives are included in the table.

Target materials were chosen specifically for their transmutation products after absorbing an alpha particle. Equation 9 demonstrates an X(α,n)W reaction. Table 5 lists the initial material, the products produced, and the kinetic energy and scattering angle of the produced products. Table 6 and Table 7 contain nuclear properties of the target materials and the corresponding products.

α+_{y}^{z}X→_{y+2}^{z+3}W+n (Equation 9)

In Equation 9, α is the alpha particle, γ is the atomic number of the target material, z is the atomic mass of the target material, and n is the neutron emission from the reaction. X is the target material and W is the product of X after transmutation.

TABLE 5
Target materials and corresponding products

| Target | Product |
|---|---|
| (X) | (α, n) |
| ⁹Be | ¹²C |
| ¹⁰Be | ¹³C |
| ¹⁹F | ²²Na |
| ²²Ne | ²⁵Mg |
| ²³Na | ²⁶Al |
| ²⁵Mg | ²⁸Si |
| ²⁷Al | ³⁰P |
| ²⁹Si | ³²S |
| ⁴¹K | ⁴⁴Sc |
| ⁴⁵Sc | ⁴⁸V |
| ⁴⁸Ti | ⁵¹Cr |
| ⁵¹V | ⁵⁴Mn |

TABLE 6
Target material properties

| Target | | atomic |
|---|---|---|
| (X) | abundance | weight |
| ⁹Be | 1 | 9.01218207 |
| ¹⁰Be | N/A | 10.01353469 |
| ¹⁹F | 1 | 18.9984031629 |
| ²²Ne | 0.0925 | 21.991385109 |
| ²³Na | 1 | 22.989769282 |
| ²⁵Mg | 0.1 | 24.98583696 |
| ²⁷Al | 1 | 26.98153841 |
| ²⁹Si | 0.04685 | 28.9764946652 |
| ⁴¹K | 0.067302 | 40.961825258 |
| ⁴⁵Sc | 1 | 44.9559075 |
| ⁴⁸Ti | 0.7372 | 47.94794093 |
| ⁵¹V | 0.9975 | 50.9439569 |

TABLE 7
Product nuclear properties

| | | | gamma energy | emission |
|---|---|---|---|---|
| Product (W) | Half-life (s) | Decay (s) | (Mev) | rate |
| ¹²C | Stable | 0 | N/A | N/A |
| ¹³C | Stable | 0 | N/A | N/A |
| ²²Na | 82050365 | 8.45E−09 | 1274 | 0.9994 |
| ²⁵Mg | Stable | 0 | N/A | N/A |
| ²⁶Al | 2.26E+13 | 3.07E−14 | 1808 | 0.9976 |
| ²⁸Si | Stable | 0 | N/A | N/A |
| ³⁰P | 149.9 | 4.62E−03 | 2235 | 0.00059 |
| ³²S | Stable | 0 | N/A | N/A |
| ⁴⁴Sc | 14292 | 4.85E−05 | 1157 | 0.999 |
| ⁴⁸V | 1.38E+06 | 5.02E−07 | 983.5 | 0.9998 |
| ⁵¹Cr | 2.39E+06 | 2.90E−07 | 320 | 0.0919 |
| ⁵⁴Mn | 2.70E+07 | 2.57E−08 | 834.8 | 0.9998 |

Device Geometry:

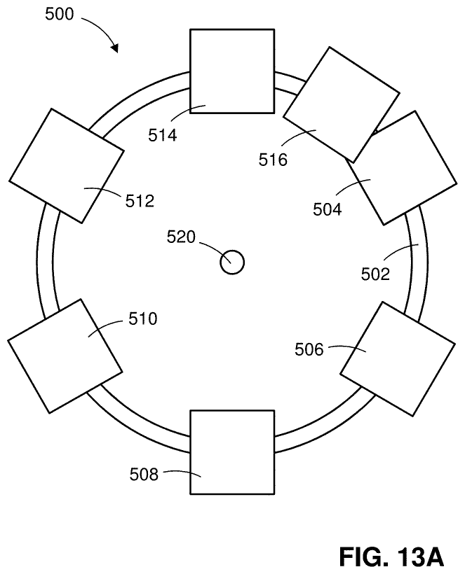

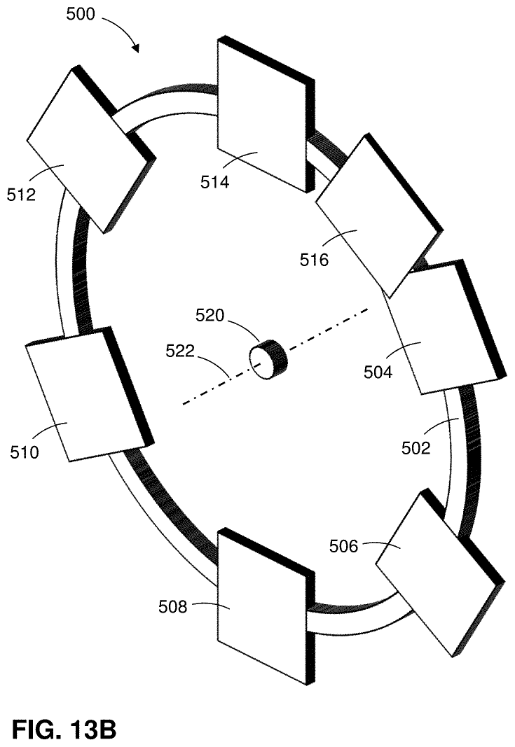

Above descriptions of particular embodiments of switchable source devices and the corresponding drawings are to be taken as cumulative with further embodiments. For example, a rotary switchable source device 500 according to at least one other embodiment is shown in FIGS. 13A and 13B. The device 500 includes an annular base ring 502 on which multiple target panels 504-514 are mounted in a circular arrangement. The base 502 may be annular as illustrated or may be otherwise circular or just rotatable relative to the arrangement of target panels. The target panels 504-514 may include different respective target materials. In the illustrated embodiment, a single source panel 516 that can be selectively aligned with any one of the target panels 504-514. The source panel 516 may for example be constructed as the source assembly 100 (see FIG. 1).

In FIGS. 13A-13B, primary radiations emitted by the source panel 516 can reach a selected target panel 504-514, where secondary radiation or radioactivity can be produced, according to alignment with the selected target panel. The rotary switchable source device 500 is operated by rotary movement of the target panels 504-514 relative to the source panel 516. Once a target panel is partially or fully aligned with the source panel 516, source-target interactions occur and consequent secondary radiations are produced. Thus, the rotary switchable source device 500 can be turned on and off by placing the source panel 516 in full-alignment and out-of-alignment positions relative to a selected target panel. The secondary radiation production rate or intensity can be controlled via partial alignment.

The rotary device 500 will allow for multiple neutron energies and fluxes depending on the target materials. The neutron flux generated by the target materials may be changed by changing the size and thickness of the targets, increasing the distance between the source and the target materials, and the strength of the source. The geometry of the rotary device and the materials may vary in size depending on the application.

Expected Activities and Products:

The activities of activated foils were calculated using Mathcad 15 by utilizing coupled differential equations. The alpha-capture cross sections for each of the foil materials were interpolated for an energy of 5.48 MeV. Activities of activated foils and neutron production rates were calculated for 1 Ci, 0.1 Ci, and 10 mCi sources of ²⁴¹Am. Each foil had a mass of 1 g.

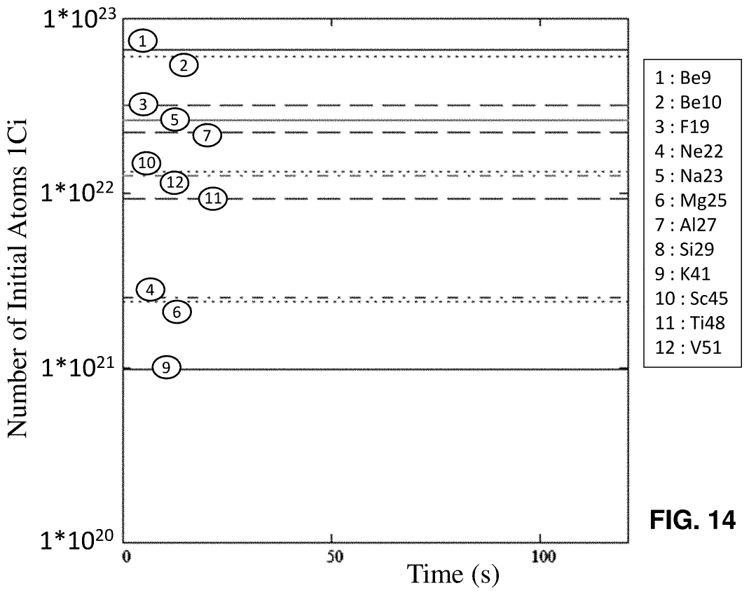

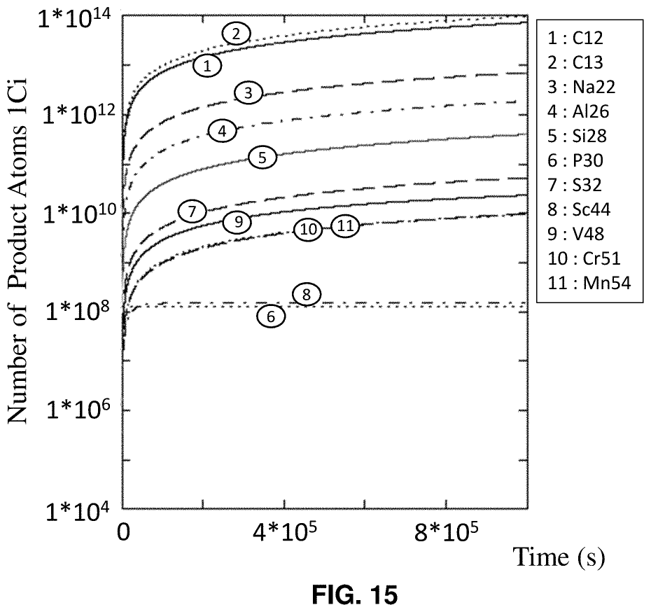

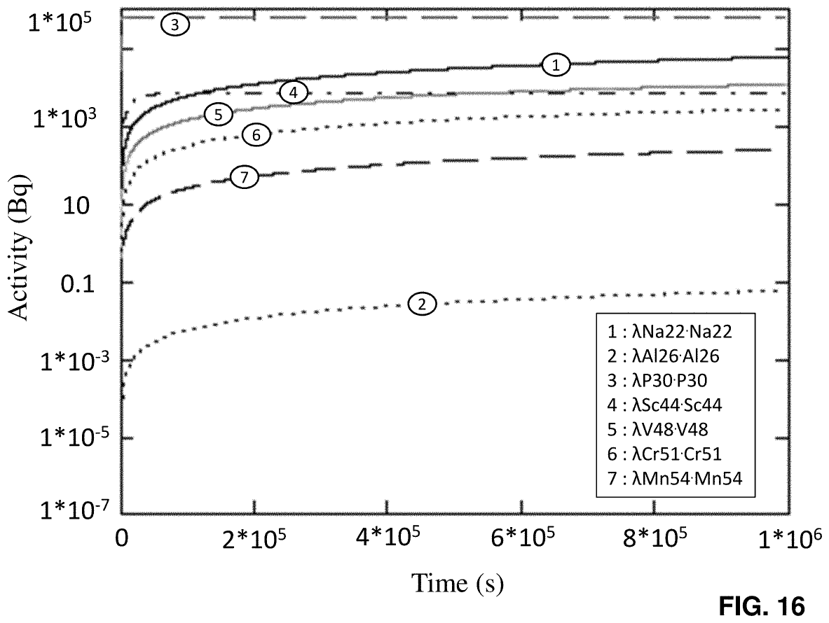

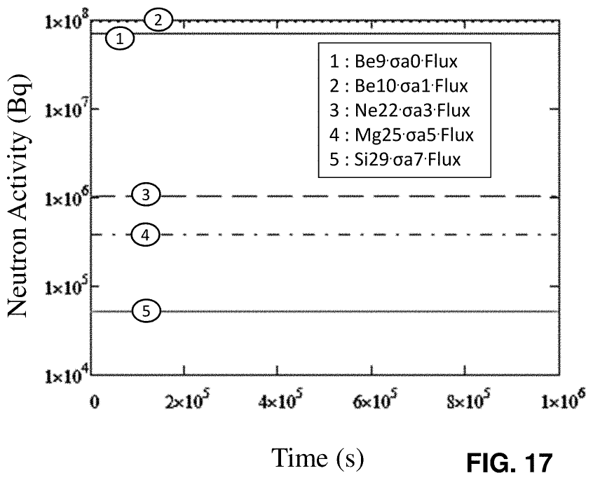

FIG. 14 is a plot, for several isotopes, of the number of initial atoms in calculations with an Am-241 source (1 Ci). FIG. 15 is a plot of the number of product atoms in the Am-241 (1 Ci, FIG. 15) calculations. FIG. 16 is a plot of activities of produced foils in the Am-241 (1 Ci, FIG. 15) calculations. FIG. 17 is a plot of neutron emission rate from target foils in the Am-241 (1 Ci, FIG. 15) calculations.

Similar calculations as those for which the results are shown in FIGS. 14-16 (1 Ci Am-241) were performed for a 0.1 Ci ²⁴¹Am source. This reduced the order of magnitude of product atoms (relative to FIG. 15) and activity of produced foils (relative to FIG. 16) by one. Similar calculations were also performed for the 10 mCi ²⁴¹Am source. This further reduced the order of magnitude of the product atoms and foil activities by one, demonstrating the results varied to scale with source activity. All cross sections and decays were kept the same.

In the following descriptions, alpha-neutron reactions are used for active interrogation techniques to identify materials and their concentrations by using pulsed neutrons and Prompt Gamma Neutron Activation Analysis (PGNAA). In non-limiting implementation of the switchable radioisotope generators described above, alpha-induced reactions are used to create the neutrons. An alpha emitting isotope will react and bombard a stable isotope, creating a compound nucleus between an alpha particle and the target nucleus. The compound nucleus will be in an excited state, and emit gammas, neutrons, and or protons depending on the material of the target. Target materials are specifically chosen to maximize secondary neutron production. The angular-energy distribution of the secondary neutrons is dependent on the energy of the incoming alpha particles and the target material. A thin sheet of non-metal material may shield the alpha particles from interacting with the target nucleus, allowing to turn the target material source on and off. This is utilized to create a pulsed effect to identify fissile materials by measuring delayed neutrons from subcritical multiplication. The systems and devices may be scaled to allow for different neutron fluxes, which is proportional to the count rate when using PGNAA. Increasing the activity of the alpha source will result in more neutrons produced by the target material through alpha-neutron reactions. Non-limiting examples of use include National Nuclear Security Agency (NNSA) and Homeland Security uses. Determining material composition is dependent on the amount of fluence created by the switchable neutron generator.

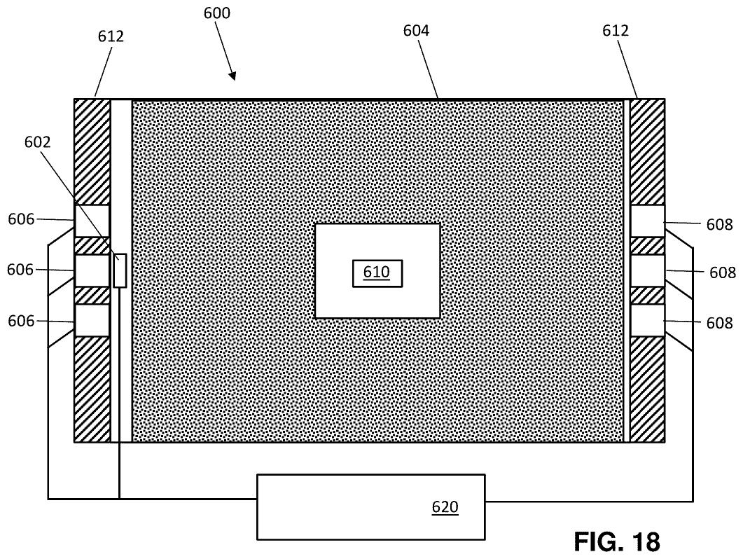

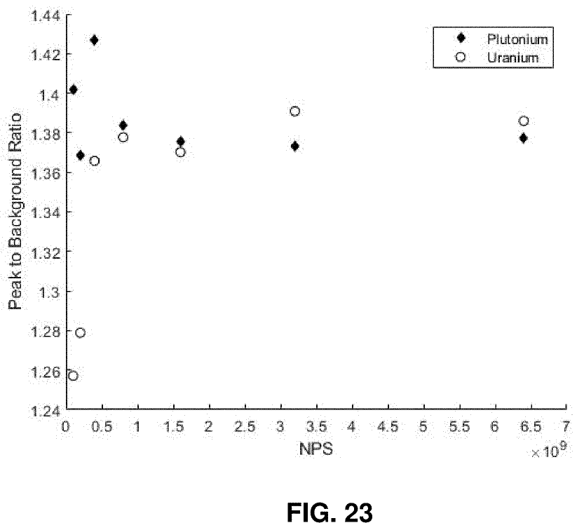

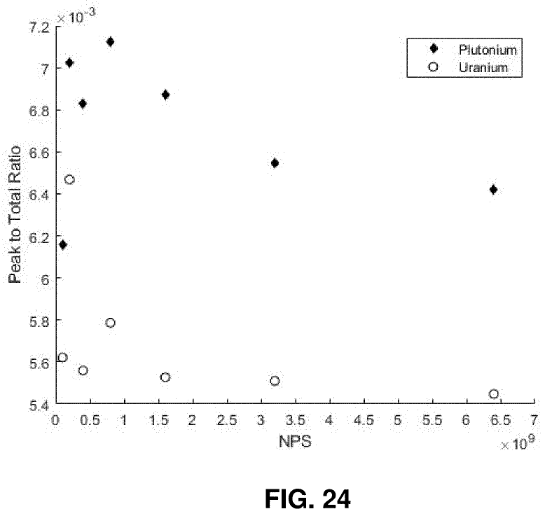

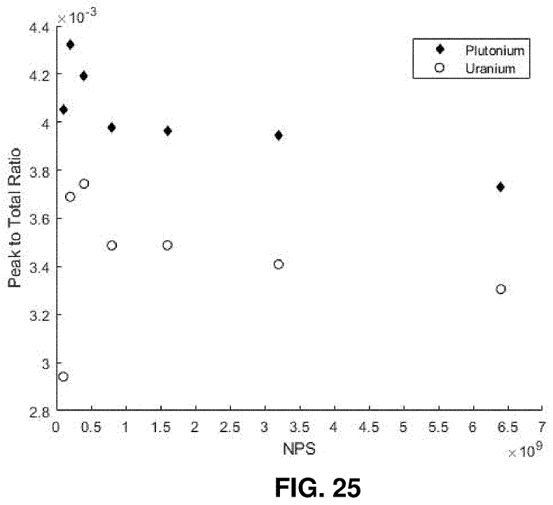

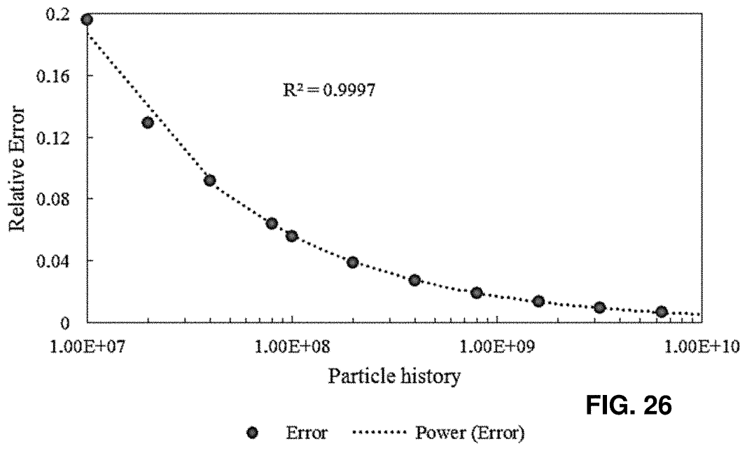

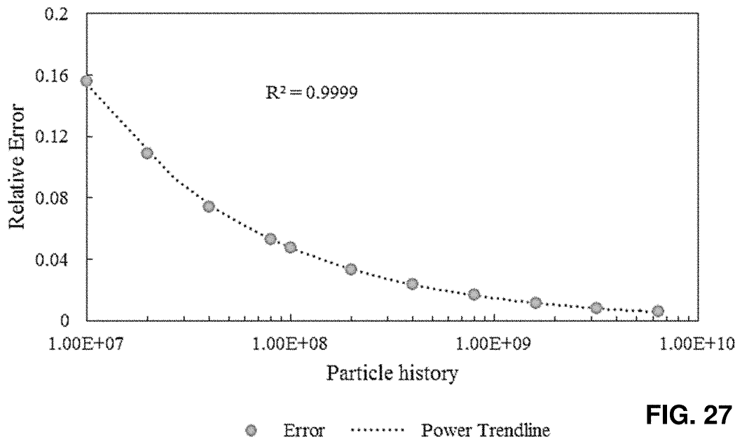

The following section describes, with reference to FIGS. 18-27, systems and methods for active interrogation of special nuclear material containers using AmBe quasi-forward biased directional source and PGNAA.

Special Nuclear Material (SNM) including 95% ²³⁵U and ²³⁹Pu can be identified by utilizing a quasi-forward directional AmBe source using Prompt Gamma Neutron Activation Analysis (PGNAA). Non-limiting examples of such sources are described in U.S. non-provisional utility patent application Ser. No. 16/027,632, published as US2019/0013109 A1. Simulations using Monte-Carlo N-Particle transport 6.2 (MCNP) and modeled HPGe and LaBr₃ detector arrays were used to identify and quantify the peak-to-background and peak-to-total ratios of the associated photon spectra from SNM encased in a polyethylene shield. The conducted simulations varied the volume of the SNM and neutron source strength in the MCNP data card to conduct an uncertainty analysis. Photopeaks identified include K-shell X-rays from ²³⁵U and ²³⁹Pu, 61 keV from fission, 2.223 MeV prompt gamma from hydrogen, 511 keV annihilation, and a single and double escape peak from the prompt gamma interaction from hydrogen. Relationships between peak-to-total and peak-to-background as a function of SNM and particle history were investigated to aid in the analysis. The capabilities of both detector systems to acquire well resolved photopeak with a 5% relative error or less, with a 1 Ci source activity, and a peak-to-background ratio of 1.15. This was determined to take 326 seconds for LaBr₃ and 163 seconds for HPGe which is comparable to current methods for material detection which take between 100-900 seconds to acquire.

In new methods and systems described herein, PGNAA is used to identify SNM, consisting of High Enriched Uranium (HEU) and Weapons Grade Plutonium (WGPu) using High Purity Germanium (HPGe) and Lanthanum-Bromide (LaBr₃) detectors. Semiconductors such as HPGe have significantly higher energy resolution (0.3-1% at 662 keV) whereas scintillators such as LaBr3 have an energy resolution of 2.8-4.0% at 662 keV. This energy resolution improvement has benefits in terms of identifying materials that are similar in photopeak energy, which should be obvious to the reader. The better the energy resolution the more potential photopeaks the detector can resolve within a given energy range. However, these two detectors have downsides associated with operation. HPGe detectors require cryogenic cooling to maintain the internal band structure. LaBr₃ scintillators are relatively stable and do not require cooling. The only potential problem with LaBr₃ is the fact that the crystal is hygroscopic which can be mitigated by water resistant detector housing. For this analysis both detectors can resolve the photopeaks of interest, but the low energy k-shell peaks (61-105 keV) is better resolved by HPGe. Ultimately the choice for detector should come down to user needs and operational environment.

By using PGNAA, as opposed to measuring delayed neutron production, the SNM and shielding material may still be identified though photopeak analysis along with the location and quantity based on the counts under each full energy photopeak for each detector. Sensitivity analysis was done by comparing peak-to-total and peak-to-background ratios of each photopeak as the number of source particles and amount of SNM changes. These simulations were done within MCNP 6.2 with ENDF VIII.0 cross section libraries. The neutron source used in these simulations is a switchable radioisotope generator, for example as described in patent application publication no. US20190013109A1.

Neutrons from the source are emitted with spectrum peaks at 3 and 4.5 MeV, which are more readily lower energy than neutrons produced from D-T (deuterium-tritium) generators. The switchable source has certain benefits over current methodologies utilized at ports of entry. One, the system is relatively self-contained, which means that there is not a need for a large power draw in potentially remote areas. Two, the radioisotope generator concept is far more portable than large scale D-T generators or X-ray imaging systems. The methods and systems described herein, however, are mean to supplement, not necessarily replace the Vehicle and Cargo Inspection System (VACIS). The methods and devices described herein may be implemented, for example, without acquiring reconstructed images of shipping containers. However, this switchable radioisotope generator can provide data regarding material content without the need for tracks or complex reconstruction algorithms. It would also be possible to utilize source localization to acquire an approximate location of the material without the need for imaging equipment.

METHODS: To simulate the PGNAA photon spectra created from varying amounts of different SNM, input cards within MCNP 6.2 were constructed. The modeled geometry is visualized using MCNPX visual editor as displayed in FIG. 18, representing a system 600 for detecting, as a non-limiting example, special nuclear material (SNM). The MCNP input card, representing the system 600 in FIG. 18, included a ²⁴¹Am source with a beryllium foil target, referenced as the SRG AmBe source 602. The ²⁴¹Am source was modeled after a source obtained through Eckert and Ziegler. The beryllium foil target has a thickness of 25 micrometer, and a width and length of 2.54 cm. The SDEF was specified within the beryllium foil, as all neutrons produced from (α, n) reactions occur there. The neutrons were directed towards a container 604, a non-limiting example of which is a hollow polyethylene cube with a thickness of 14 cm between the detectors and the SNM. The detectors used in the simulations included HPGe detectors 606 and LaBr₃ detectors 608. Each detector had a diameter of 2.54 cm and 2.54 cm in length. A 3×3 detector array was placed on the left and right side of the container 604. Inside the container 604, an SNM source 610 (95% ²³⁵U or 95% ²³⁹Pu) of varying volumes of ²³⁹Pu and ²³⁵U was placed, none of which exceeded 0.95 K_{eff}.

To obtain the net photon spectrum from each variation, F8 photon tallies were applied to each detector cell in the array. Each F8 tally was equally divided into 4096 equal bins from zero to 10 MeV for both LaBr₃ and HPGe detectors. Simulations with and without SNM were done, and each set of corresponding tallies were subtracted from one another to generate the net spectra. Each F8 tally was processed in Python 3.6 to use gaussian broadening parameters found in a FT GEB tally in the MCNP manual. This was done with post-processing as the gaussian broadening parameters are not final. Gaussian broadening parameters used correspond to previous work, and may be adjusted in simulations according to these descriptions to match experimentations. This was accomplished by parsing MCNP output files with Python. Areas under each of the photopeaks from PGNAA were compared to the area of the total spectrum for various particle history. The number of particles per simulation ranged from 10⁷ to 10¹¹ to replicate the statistics of counting in real time. This resulted in finding the minimum particle history and acquisition time required for determining if an isotope is present and to what degree of certainty. The signal from the PGNAA spectra is dependent on the amount of SNM present and is proportional to the amount of SNM. Varying amounts of SNM were used to quantify the mass of SNM to the signal of the PGNAA spectra.

In previous work, the angular-energy distribution of a directional AmBe source was investigated. This was done using series of conical surfaces. Each cone was spaced by a 1° angle and bound by inner and outer spheres. Each of these angular cones was labeled as a different cell, and F4 neutron tallies were applied to 181 cells. Each tally had a bin width of 0.1 MeV from 0-12 MeV to find the energy dependence at each angle. The angular-energy dependence from each tally was used to write an equivalent source definition in MCNP.

The SDEF used for all MCNP input cards included a volumetric neutron source with energy being a function of direction and angle. There were 185 source distributions used for the volumetric source. Three of the source distributions bound the geometry of the volumetric neutron source inside the beryllium foil. One source distribution was used primarily for emitting neutrons along the x-axis. The remaining source distributions were used to define the neutron energy spectrum for each direction of emission. This was accomplished using a distribution card. To speed up computational time and increase sampling history for PGNAA, the neutron source was biased to emit neutrons within a forward 10° angle of emission along the x-axis. A convolution factor of 125.6 was used as a correction factor when calculating acquisition times with varying source activities.

The materials used in MCNP input card include beryllium, polyethylene, tungsten, air, and the material definition of the 90 microCi ²⁴¹Am source. The ²⁴¹Am source contains a silver backing and a gold plating, with americium between the two. Air was used to fill areas around the neutron source, detectors, and inside the hollow polyethylene cube. Tungsten was used as a shielding material, referenced as walls 612 in FIG. 18, partially surrounding the detectors to prevent photons from scattering from within the polyethylene and interacting with the sides of the detectors. Tungsten was able to attenuate photons below 40 keV, allowing for a clear 61 keV photopeak to be observed from fission. For SNM, ²³⁹Pu and 95% enriched ²³⁵U were used in the simulations, with ²³⁸Pu and ²³⁸U making up the remainder. Alpha-phase ²³⁹Pu and ²³⁵U were used in the simulations with densities of 19.2 cm³ and 18.9 cm³ respectively.

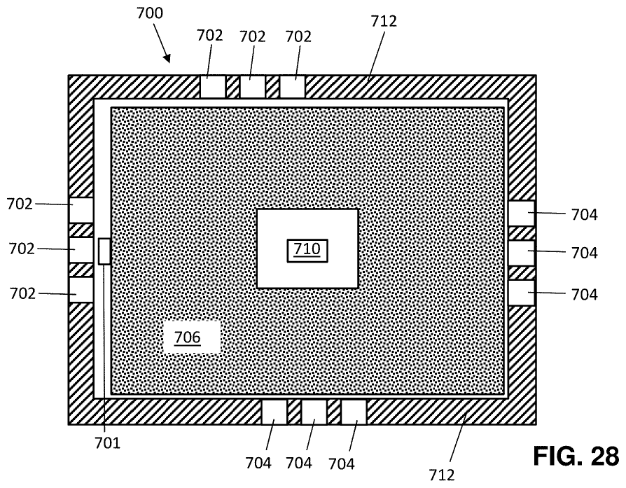

The system 600, as represented in FIG. 18, may further include a control system 620 in electrical communication with the switchable source 602. The control system 620 is configured to control the switchable source 602 to selectively irradiate the material under interrogation, as represented by the SNM source 610, with neutrons. The control system 620 is in electrical communication with the detectors 606 and detectors 608 to receive signals therefrom, the signals conveying information for use in detecting count events at the detectors. The control system 620 may provide electrical power to the source 602 and detectors for their activation and control. The control system may include a computing device including a processor for generating data based on the signals from the detectors and for computing results from the data, for example by use of equations 10-14 in the implementations of FIGS. 28-29 and 32. The control system 620 may include, or send signals and data to, a display and/other output devices for viewing access by users. The control system 620 may include one or more user interface devices for control of the system 600.

Material cards used in the MCNP simulations are listed in the following MCNP 6.1.1 example material input deck:

| | | |
|---|---|---|
| m8 | 95241 1.0 | $ Americium |
| m9 | 4009 1.0 | $Beryllium |
| m10 | 79197 1.0 | $Gold |
| m11 | 47107 0.51839 47109 0.48161 | $ Silver |
| m12 | 6012 0.000150 7014 0.784431 8016 0.210748 18040 0.004671 | $ Air |
| m13 | 57139 1 35081 3 | $ LaBr₃ |
| m14 | 11023 1 | $ Na target |
| m15 | 79197 1 | $ Au target |
| m16 | 94239 −0.93 94238 −0.07 | $ High enriched Pu target |
| m17 | 1001 1 | $ H target |
| m18 | 92235 −0.93 92238 −0.07 | $ High enriched U target |
| m19 | 74000 −0.9 28000 −0.05 26056 −0.05 | $ Tungsten |
| m20 | 6012 2 1001 4 | $ polyethyline |
| m24 | 6012 1.0 1001 1.104 | $ BC-408 |

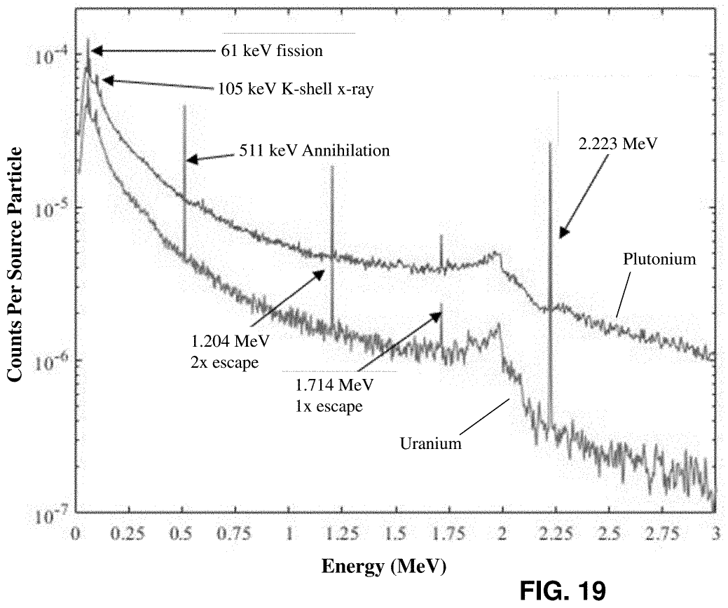

RESULTS: F8 photon tallies were processed through Python to export the data. MATLAB was then used to produce the following figures. PGNAA was utilized to examine varying amounts of SNM and particle histories to see how the produced spectra changes over the two detector arrays and their constituents. The figures presented isolate each of these variables to see the change in the spectra. FIGS. 19-21 were generated using a particle history of 10⁸ neutrons. The photon spectra for 256 cm³ of plutonium and uranium are compared in FIG. 19, which shows a PGNAA spectra for a rear detector array for 256 cm³ of SNM with HPGe detectors and a 10⁸ particle history. The peaks obtained in the spectra correspond to materials emitting prompt gammas due to (n, p) reactions and fission. Photopeaks due to fission are seen at 61 keV and 68.4 keV and are mapped back to plutonium and uranium present in the simulations. This became a summation peak at 61 keV for the LaBr₃ detector after gaussian broadening was applied. K-shell x-rays are present at 105 keV and contribute to a small peak in the spectra. The peak at 2.223 MeV comes from prompt gammas from hydrogen after a (n, p) reaction occurs. Peaks at 1.714 MeV and 1.204 MeV were from single and double escape peaks from the prompt gamma emitted by hydrogen. The peak at 511 keV arises from pair production in the shielding material of the detector system in which an annihilation photon deposits its energy into the detector. The total number of counts in the spectra is proportional to the amount of SNM present in the simulations and the type of SNM present. It is expected that more counts in the plutonium spectra would be observed compared to the uranium spectra due to subcritical multiplication from the interrogating neutron source.

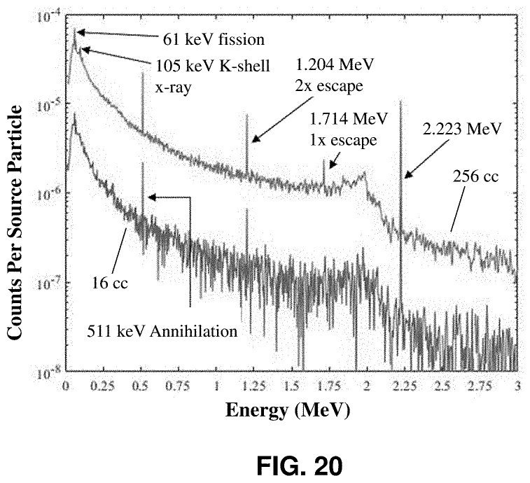

FIG. 20 shows Uranium PGNAA spectra from a rear detector array with HPGe detectors. Due to the low particle history (10⁸ neutrons) to create FIG. 20, all peaks previously mentioned were able to be identified within the 16 cm³ of HEU except for the K-shell x-rays at 105 keV from SNM and the single escape peak at 1.715 MeV from the prompt gamma from hydrogen. This was the same case with the plutonium when examining the data. This is due to less SNM being present, reducing the amount of subcritical multiplication and subsequent photons produced, leading to less sampling at the detectors.

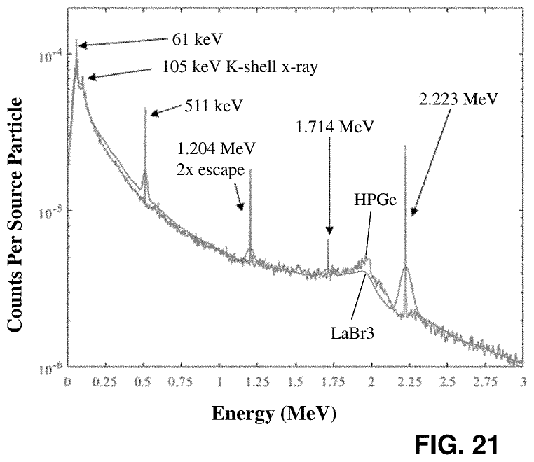

The difference between HPGe and LaBr₃ SNM detectors for PGNAA is shown in FIG. 21. Gaussian broadening was applied to each of the output spectra for HEU and WGPu to see how the spectra would change. The broadening parameters for the HPGe detectors included a, b, and c values of 5.868·10⁻⁴, 3.951·10⁻⁴, and 7.468 respectively. The broadening parameters for the LaBr₃ detectors used a, b, c values of 6.8·10⁻³, 5.8·10⁻³, and 14.95. These parameters were based on previous work since experimental validation of the simulations have not been completed. The values used in this study were vailed for the energy range up to 2.6 MeV. The a, b, c values were used to recreate the GEB card within MCNP for gaussian broadening and were implemented using Python. The larger broadening parameters used for the LaBr₃ detectors smoothed the spectra to eliminate the randomness of the F8 tallies from the simulations. The broadening parameters used for the HPGe detectors had no noticeable effect on the spectra due to the Full Width at Half Maximum (FWHM) and standard deviation being less than the binning structure of the F8 tallies. For the broadening parameters used in the HPGe F8 tallies to be more noticeable, the binning structure would have to be increased to obtain better resolution. The F8 tallies were taken to 10 MeV to see the prompt gammas emitted from carbon, nitrogen, and tungsten if those photopeaks were observed. However, the cross sections for (n, p) reactions for those materials are much lower than the cross section for (n, p) reactions in hydrogen. The background spectra produced from subcritical multiplication by SNM further drowns out these photopeaks from being observed. These peaks are seen in the gross spectra but were not found in the net spectra.

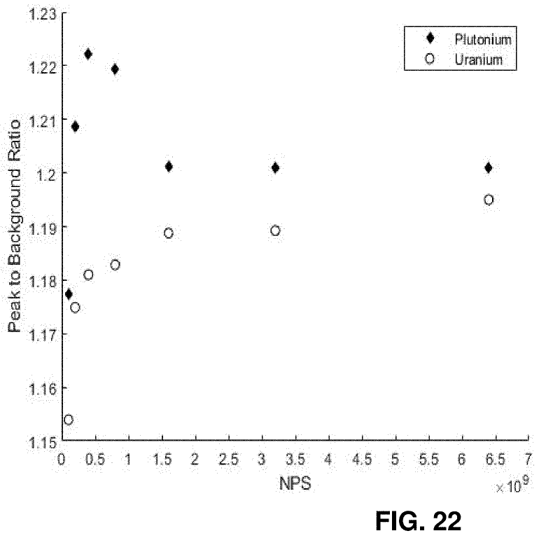

Peak-to-total and peak-to-background values for each photopeak were compared to as particle history and volume of the fuel changed. The relationships between peak-to-total and peak-to-background as NPS changes are shown in FIGS. 22-25 for the 61 keV photopeak from fission and the 2.223 MeV prompt gamma from hydrogen. All other photopeaks followed the same trend in each case. Peak-to-total and peak-to-background values were found not to change as the amount of SNM was increased. This is due to the area under the photopeaks increasing at the same rate as the total spectra, keeping the ratio the same. Peak-to-background values for the HPGe detector photopeaks were found to be above three for almost all cases except for the 61 keV photopeak from fission, which is sufficient for photopeak identification. This is further seen in Table 8. If the binning structure of the detector was finer, the broadening parameters used would have had a larger effect, decreasing the peak-to-background values. Peak-to-background values for the LaBr₃ detector were found to be above 1.15 for almost all cases except for the 61 keV photopeak from fission, which is sufficient for photopeak identification. This is sufficient for identifying materials if they are isolated but adding extra materials and noise to the system with low particle sampling would allow the SNM to screen through. Error within FIGS. 22-25 were found to have a maximum error of 5.13 percent for the 2.223 MeV prompt gamma from hydrogen and 1.09 percent for the 61 keV photopeak from fission. These errors were found to occur in the lowest particle history ran, being 10⁸. This is the binding case for the rest of the results, as higher particle histories reduce the variance.

TABLE 8
Plutonium Peak-to-Background Values for HPGe detector array

| Photopeak energies | Volume of Plutonium (cm³) | | | | |
|---|---|---|---|---|---|
| (MeV) | 25 | 55 | 82 | 114 | 256 |
| 0.061035 | 1.316 | 1.366 | 1.396 | 1.445 | 1.406 |
| 0.5127 | 5.135 | 6.821 | 5.384 | 6.113 | 5.654 |
| 1.2036 | 3.943 | 8.816 | 6.127 | 8.296 | 5.974 |
| 1.7139 | 2.040 | 2.624 | 4.616 | 2.880 | 2.590 |
| 2.2241 | 54.512 | 65.682 | 55.804 | 49.218 | 38.173 |

Uncertainty of the photopeaks within the spectra was found to have a power law relationship with the number of particles sampled. This led to diminishing returns as the NPS within the SDEF card increased. Increasing the amount of SNM left the uncertainty unchanged. With these metrics defined, the minimum particle history needed to properly identify SNM in this geometry was 2×10⁸ neutrons for a volume of 16 cm³ of SNM for a LaBr₃ detector system. The particle history value is less for HPGe detector systems with a particle history value of 10⁸ neutrons. These values were obtained with all photopeaks of interest and surrounding channels having less than five percent error, or two standard deviations. This corresponds to 1.1×10¹³ alpha particles from the switchable AmBe source used in previous work. Assuming an activity of 1 Ci, the total acquisition time would take 326 seconds for a LaBr₃ system and 163 seconds for an HPGe system. These time metrics assume no dead time within each detector array but do account for the efficiency. This is faster than previous methods used, but acquisition time may be scaled depending on the alpha source activity and the alpha emitter used. Ideally, ¹⁴⁸Gd would be used as an alpha emitter, as there is no gamma emitted with each alpha particle. This would allow for no extra gamma dose to personnel using this PGNAA system, and acquisition times proportional to the ¹⁴⁸Gd activity. The limiting factor is the current supply of this material, as quantities are only man-made. To improve acquisition times, a higher fluence of neutrons may be used to induce reactions within the SNM or other contents within the package which will scale linearly. It should be noted that longer acquisition times are inherently safer, as too many neutrons activating the SNM or contents of the package may lead to a criticality accident upon performing active interrogation.

The uncertainty of the PGNAA spectra for detecting SNM with a switchable AmBe source was quantified using both HPGe and LaBr₃ detectors within MCNP. Photopeaks from fission, K-shell x-rays, annihilation, and prompt gamma emission were identified within the spectra. The number of particles sampled in the simulations affected the variance of the peak-to-background and peak-to-total which corresponded to ratios that were not converged in each spectrum. The amount of SNM used in active interrogation was found to have minimum impact on the photon spectra with the geometry used in the simulations. The acquisition time needed to determine the presence of SNM was found to be comparable to previous methods used. The added benefit to this system is that it may be used for detecting other hazardous materials, unlike delayed neutron counting. A forward biased neutron source can implemented for active interrogation using PGNAA, as the neutrons are forward emitting and contain high energies. These findings will be used to support further development of U.S. patent application publication US 2019/0013109 A1 and neutron sources used for fast neutron imaging for non-destructive testing.

The following section describes, with reference to FIGS. 28-32, active interrogation systems and methods for source location in a scattering and absorbing medium, using PGNAA, and an AmBe quasi-forward biased directional source.

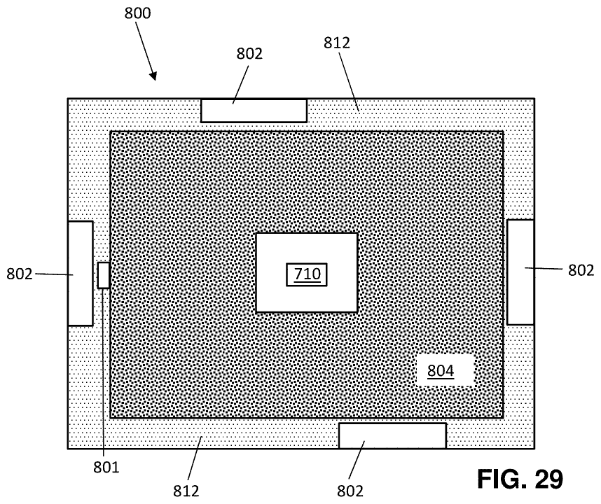

According to systems and methods described herein, source location of Special Nuclear Material (SNM) including 95% ²³⁵U and ²³⁹Pu is identified by utilizing a quasi-forward directional AmBe source, referenced as 701 in FIG. 28, and referenced as 801 in FIG. 29, as described in U.S. patent application publication US 2019/0013109 A1, using Prompt Gamma Neutron Activation Analysis (PGNAA) and neutron spectroscopy simulated with Monte-Carlo N-Particle transport 6.2 (MCNP).

FIG. 28 represents a system 700, in which HPGe detectors 702 and LaBr₃ detectors 704 are used. FIG. 29 represents a system 800, in which plastic scintillator detectors 802 were used. In each, the detectors were used identify the location of the SNM using total counts incident on each detector, and PGNAA photopeaks from HPGe and LaBr₃ detector arrays in a polyethylene shield. The conducted simulations varied the volume and location of the SNM in the MCNP input files to observe how the source location method behaved. PGNAA photopeaks used for source identification include 61 keV from fission, 2.223 MeV prompt gamma from hydrogen, 511 keV annihilation, and a single and double escape peaks from the prompt gamma interaction from hydrogen. The capabilities of each detector systems to acquire well resolved photopeaks with a 1% relative error or less, and total relative error for F4 and F8 tallies were less than 0.015% relative error. Source predictions of the SNM with uneven amounts of polyethylene shielding between the source and detectors was observed to overpredict and give invalid source location predictions. Source locations of the SNM with even amounts of polyethylene material between the source and each detector were found to be valid. With a 1 Ci ²⁴¹Am source activity, it was determined that 1630 seconds were needed to obtain the results for each detector system with the quasi-forward directional AmBe source. Coupling source and material identification together would increase acquisition time but would only require one system to determine.

In these descriptions, prompt gamma neutron activation analysis (PGNAA) is used in conjunction with a source localization regime to attempt to determine not only if special nuclear material (SNM) is present, but where it is located within the container volume. PGNAA is an active interrogating technique that utilizes neutrons, preferably thermal neutrons, to induce an (n,p) reaction. The resulting prompt gamma can be used for isotope identification. To induce this reaction, the chosen neutron source is a switchable radioisotope generator described in U.S. patent application publication US 2019/0013109 A1. The switchable radioisotope generator has some benefits over spontaneous fission sources and D-T generators. The spontaneous fission sources such as ²⁵²Cf are limited by the flux of spontaneous fission neutrons, and therefore can be problematic in determining the presence of SNM in well shielded environments. D-T generators require a power draw in order to work, unlike the switchable radioisotope generator which can be self-sufficient.

Source localization allows the user to determine, using an array of detector positions, an approximate location of where a source is located. This technique can be applied to stationary port of entry scanning systems to detect SNM or constituent gamma emitters that can be utilized for a dirty bomb. While this technique is not new in engineering, it can be a useful addition to the development of new and more robust scanning systems for national security applications. Source localization as a technique relies on utilizing detection positions in tandem to determine through statistical means where a source may reside. It should be noted that an increased count rate within any given detector is not necessarily indicative of the location of a source. Multiple detector positions are needed to localize. This localization can manifest as a statistical process such in which point source localization is defined as a function of Bayesian statistics.

Within a Bayesian framework the user has the ability to know the probability distribution for activity and position of an unshielded source. This does differ from the proposed purpose as that work focused on mobile source localization whereas the manuscript focuses on a stationary system. Other techniques such as difference of time of arrival (DTOA) have been used as well. DTOA relies on utilizing the distance differences of sensors to determine an approximate location of a source. This is a common technique in the aerospace field. DTOA does have a drawback, however. If fewer sensors are used it is possible for noise to be introduced either through measurement errors or a stochastic process such as radioactive decay. The main way to counteract this is to use more than three sensor systems. The main issue with utilizing a robust regime is the addition of attenuating material. Most localization regimes are valid in non-attenuating media where the gamma ray or neutron can travel further distances.

This method is a three-dimensional Cartesian real-time algorithm that can be used for accurate source positioning within a non-attenuating medium. This method utilizes a discretized domain which meshes the source domain into finite cell volumes, and it is possible to localize a source within 2-3 minutes of measurement. However, these descriptions apply it to an attenuating medium for neutrons and gammas.

For the source localization analysis using PGNAA, a LaBr₃, HPGe, and BC-408 detector systems will be examined for isotopic identification and source localization. Semiconductor and Scintillators are in constant competition in the realm of gamma spectroscopy. The tradeoff between efficiency and energy resolution is a constant point of concern for detection parameters. Scintillators such as LaBr₃(Ce) have much lower energy resolution (2.8-4.0% at 662 keV) compared to HPGe which has a significantly better resolution (0.3-1% at 662 keV). The improvement in energy resolution from scintillator to semiconductor allows users to identify full energy peaks in proximity together. However, scintillators have greater full peak efficiencies. LaBr₃ is a decent tradeoff between efficiency and energy resolution. Compared to NaI(Tl), which has an energy resolution of 7% at 662 keV, LaBr₃(Ce) allows the user to resolve more full energy photopeaks within a given energy width. This improvement in energy resolution still pales in comparison to the HPGe. However, scintillators offer stability at room temperature and require no cryogenic or electric cooling unlike HPGe semiconductor detectors. The main downside to outside use of scintillators is that many of them are hygroscopic, which means the properties change in the presence of water, therefore water-resistant housing is needed. This is true for neutron scintillators as well, including BC-408, which has polyvinyltoluene as a base material. The BC-408 scintillator emits a spectrum of light with a wavelength 425 nm and has a softening point at 70° C. BC-408 scintillators have small rise times of 0.9 ns and a decay time of 2.1 ns, which are important for neutron time-of-flight (nTOF) measurements.

METHODS: A source location method used for determining the location of SNM within the package utilizes four different detector positions to be known and the radiation intensity at each detector for a three-dimensional geometry. A system of four nonlinear equations is solved to determine the location of the SNM inside of the package. The source location method used relied on an inverse square law, meaning that the radiation intensity given off by either neutrons or gammas is inversely proportional to the square of the distance from the source. In the case for multiple detectors, this means the radiation intensity multiplied by the distance squared is equal for all detectors, as seen in Equation 10 [17]. For a three-dimensional geometry, Equation 11 is used for each detector to relate a radius to Cartesian coordinates.

I₁r₁²=I₂r₂²=Iᵢrᵢ² (Equation 10)

(x−xᵢ)²+(y−yᵢ)²+(z−zᵢ)²=rᵢ² (Equation 11)

rᵢ²=I₁/Iᵢr₁2 (Equation 12)

(x−xᵢ)+(y−yᵢ)²+(z−zᵢ)=I₁/Iᵢr₁² (Equation 13)

By solving for one radius in terms of another and multiplying by the ratio of radiation intensities in Equation 12 and substituting back into Equation 11, this yields Equation 13 with four unknowns. The four unknowns include the x, y, z coordinate of the SNM and the distance of one detector from the SNM. This would take a minimum of four detector positions and responses to solve the system of equations. The standard deviation for this method is given in Equation 14. This method was developed to be used in a non-attenuating medium, which holds true for photons interacting within polyethylene due to low interaction probabilities. For neutrons, it is assumed that since the amount of polyethylene between the SNM source and each detector is relatively the same, the attenuation and scattering within the polyethylene towards each detector is equal and will still provide a valid source prediction. This is later proved to be true within the results section. For the simplicity of this work, nTOF analysis was not done in MCNP due to resolving the energy spectra between two BC-408 scintillator detectors. If two BC-408 scintillator plates were used in conjunction, the time taken for each neutron passing between then would be recorded and used to find the energy of each neutron. This has been well established in prior work, so F4 tallies were used instead to obtain the neutron energy spectra and total fluence for each BC-408 scintillator plate.

σ=Std(I₁r₁²,I₂r₂², . . . Iᵢrᵢ²) (Equation 14)

To simulate the PGNAA photon spectra and neutron spectra created from varying amounts of different SNM and to determine the location of the SNM inside the package, input cards within MCNP 6.2 were constructed. The MCNP input cards used included a ²⁴¹Am source with a beryllium foil target. The ²⁴¹Am source was modeled after a source obtained through Eckert and Ziegler. The beryllium foil target has a thickness of 25 micrometers, and a width and length of 2.54 cm. The SDEF was specified within the beryllium foil, as all neutrons produced from (α, n) reactions occur there. The neutrons were directed towards a hollow polyethylene cube with a thickness of 14 cm between the detectors and the SNM. The detectors used in the simulations included HPGe and LaBr₃ for PGNAA. Each of the LaBr₃ and HPGe detectors had a diameter of 2.54 cm and 2.54 cm in length. The HPGe and LaBr₃ detectors were placed in four 3×3 arrays for increased sampling. For neutron detection, BC-408 was used as the neutron scintillator for neutron spectroscopy. A single 2.54×10.54×10.54 cm³ sheet was used to record the energy of the neutrons. These dimensions were chosen to match the array size of each HPGe and LaBr₃ detector array. Four HPGe/LaBr₃ arrays or BC-408 plates were placed around the package geometry at varying locations. The location of each detector array or BC-408 scintillator plate is displayed in Table 8. The center location of each detector array was used for determining the location of the SNM inside the hollowed cube. Inside the hollow cube, varying volumes of ²³⁹Pu and ²³⁵U were placed, none of which exceeded 0.95 K_{eff}. The modeled systems 700 and 800, as visualized using MCNPX visual editor, are represented respectively in FIGS. 28 and 29. In the system 700 (FIG. 28), HPGe detectors 702 and LaBr₃ detectors 704, and a material under interrogation as represented by the SNM source 710 (95% ²³⁵U or 95% ²³⁹Pu) were modeled. In the system 800 (FIG. 29) BC-408 scintillator plates 802, and the SNM source 710 (95% ²³⁵U or 95% ²³⁹Pu) to be interrogated were modeled. Two source locations were used with the methodology specified in Equations 10-14. The primary SNM location used in these simulations was (20, 0, 0) with a secondary location at (10, −9, −9) to show how a scattering and absorbing medium affects the detector results and source location predictions.

Each of the systems 700 and 800 may further include the control system 620 as shown in FIG. 18 and described with particular reference thereto. In each system the control system 620 is configured to control the respective switchable source and corresponding detectors and accordingly is in electrical communication with the source and detectors of each system, for example as represented for the system 600 in FIG. 18.

To obtain the net photon spectrum from each variation, F8 photon tallies were applied to each detector cell in the array. Each F8 photon tally was equally divided into 4096 equal bins from zero to 10 MeV for both LaBr₃ and HPGe detectors. Simulations with and without SNM were done, and each set of corresponding tallies were subtracted from one another to generate the net spectra. Each F8 tally was processed in Python 3.6 to use Gaussian broadening parameters found in a FT GEB tally in the MCNP manual. This was done with post-processing as the Gaussian broadening parameters are not final. Gaussian broadening parameters used in this study correspond to previous work, and will be changed later to match experimentation. This was accomplished by parsing MCNP output files with Python. The net area under each of the photopeaks from PGNAA were used for locating the SNM source, along with the total counts found in the net tallies. F4 tallies were placed over the BC-408 plate cells to record the neutron fluence. Each F4 tally used was equally divided into 80 equal bins from zero to 10 MeV for BC-408 scintillator detectors. This course binning structure was chosen due to detector binning used in current neutron spectroscopy systems and there being no visible peaks coming from the HEU and WGPu. Only the total fluence of each F4 tally was used to determine the location of the SNM source. The number of particles per simulation was 10⁹ for reduced uncertainty less than one percent. The source locations determined by HPGe and LaBr₃ detector arrays and BC-408 scintillator plates were compared for accuracy. Signal from the PGNAA spectra is dependent on the amount of SNM present and is proportional to the amount of SNM. Varying amounts of SNM were used to quantify the source location and how the source location method broke down as the size of the volumetric source increased.

The angular-energy distribution of a directional AmBe source was determined using series of conical surfaces. Each cone was spaced by a 1° angle and bound by inner and outer spheres. Each of these angular cones was labeled as a different cell, and F4 neutron tallies were applied to 181 cells. Each tally had a bin width of 0.1 MeV from 0-12 MeV to find the energy dependence at each angle. The angular-energy dependence from each tally was used to write an equivalent source definition in MCNP

The SDEF used for all MCNP input cards included a volumetric neutron source with energy being a function of direction and angle. There were 185 source distributions used for the volumetric source. Three of the source distributions bound the geometry of the volumetric neutron source inside the beryllium foil. One source distribution was used primarily for emitting neutrons along the x-axis. The remaining source distributions were used to define the neutron energy spectrum for each direction of emission. This was accomplished using a distribution card. To speed up computational time and increase sampling history for PGNAA, the neutron source was biased to emit neutrons within a forward 10° angle of emission along the x-axis. A convolution factor of 125.6 was used as a correction factor when calculating acquisition times with varying source activities.

The materials used in MCNP input card include beryllium, polyethylene, tungsten, air, SNM, LaBr₃, HPGe, BC-408, and the material definition of the ²⁴¹Am source. The ²⁴¹Am source contains a silver backing and a gold plating, with americium between the two. Air was used to fill areas around the neutron source, detectors, and inside the hollow polyethylene cube, referenced as container 804 in FIG. 29, and as 714 in FIG. 28. Tungsten, referenced as walls 712 in FIG. 28, was used as a shielding material around the HPGe and LaBr₃ detectors to prevent photons from scattering from within the polyethylene and interacting with the sides of the detectors. Tungsten was able to attenuate photons below 40 keV, allowing for a clear 61 keV photopeak to be observed from fission. For the BC-408 scintillator detectors 802 (FIG. 29), only air 812 was placed around them to prevent neutrons from being scattered back into the detectors. The material composition was obtained from Saint-Gobain (BC-400, BC-404, BC-408, BC-412, BC-416 Premium Plastic Scintillators).

For SNM, ²³⁹Pu and 95% enriched ²³⁵U were used in the simulations, with ²³⁸Pu and ²³⁸U making up the remainder. Alpha-phase ²³⁹Pu and ²³⁵U were used in the simulations with densities of 19.2 cm³ and 18.9 cm³ respectively. Material cards used in the MCNP simulations are shown below (See MCNP 6.1.1 EXAMPLE INPUT DECK).

RESULTS: F8 photon tallies and F4 neutron tallies were processed through Python to export the data. MATLAB was then used to produce the following figures. The figures presented compare the source location prediction using four non-linear equations and four individual detector responses. Source location predictions were done for each PGNAA photopeak for the HPGe and LaBr₃ detector systems as volume of the SNM varied. The total photon counts from HPGe and LaBr₃ detector systems were compared with the total neutron count from the BC-408 detector system as the amount of SNM varied. All simulations utilized a particle history of 10⁹. The method used for determining source location is based off point detectors and point sources; this method was used under the assumption that volumetric sources and detectors are still valid for identifying source location.

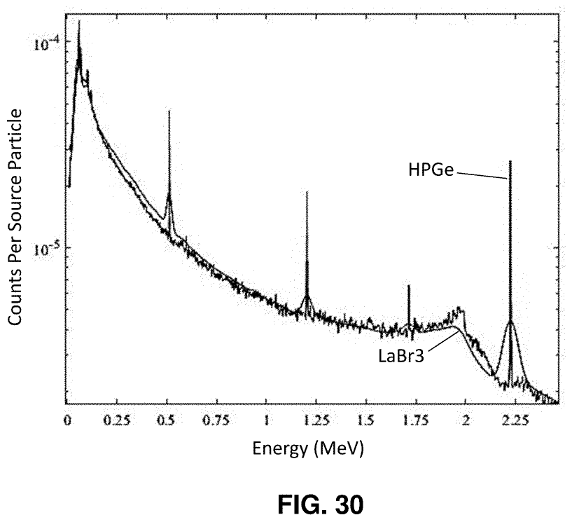

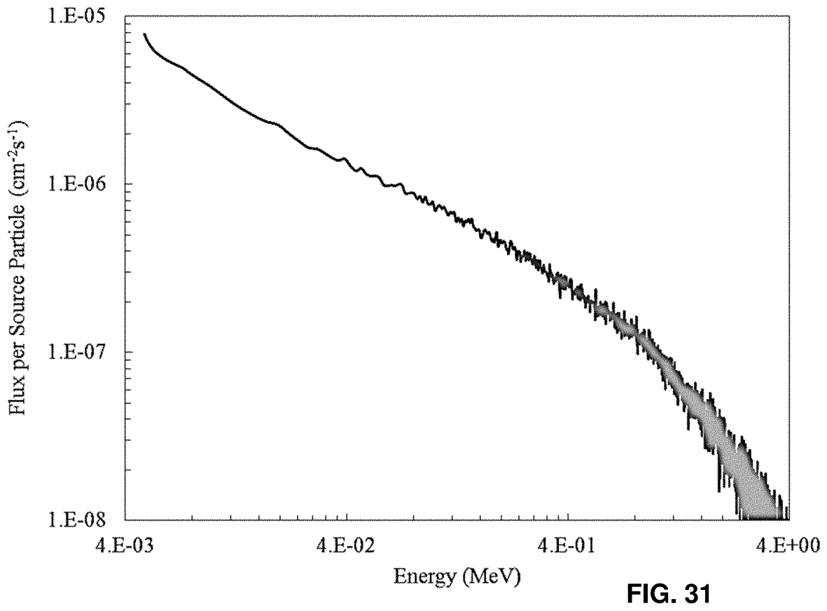

It was found that this assumption does not hold true for PGNAA photopeaks if they are not well defined or identifiable on each detector array. This was more prevalent within the HPGe detector arrays, as Gaussian broadening parameters used within Python, mirroring the MCNP GEB card, had little effect on peak broadening. The broadening parameters used for the HPGe detectors had no noticeable effect on the PGNAA spectra due to the Full Width at Half Maximum (FWHM) and standard deviation being less than the binning structure of the F8 photon tallies. For the broadening parameters used in the HPGe F8 tallies to be more noticeable, the binning structure would have to be increased to obtain better resolution. This led to inefficient PGNAA peak identification within HPGe detector arrays. Gaussian broadening was applied to each PGNAA spectra to simulate real detector response and replicate spectra obtained in previous work. The broadening parameters for the HPGe detectors included a, b, and c values of 5.868·10⁻⁴, 3.951·10⁻⁴, and 7.468 respectively. The broadening parameters for the LaBr₃ detectors used a, b, c values of 6.8·10⁻³, 5.8·10⁻³, and 14.95. These parameters were based on previous work since experimental validation of the simulations have not been completed. The values used in this study were vailed for the energy range up to 2.6 MeV. The a, b, c values were used to recreate the GEB card within MCNP for Gaussian broadening and were implemented using Python. The larger broadening parameters used for the LaBr₃ detectors smoothed the spectra to eliminate the randomness of the F8 tallies from the simulations, leading to better source location prediction. This is seen in FIG. 31. With a particle history of 10⁹ neutrons used in the simulations, not all of the PGNAA photopeaks from the produced photons were visible on all four detectors. The PGNAA spectra incident on detectors may be seen in FIG. 30. The PGNAA photopeaks used in the identification included 61 keV from fission, 511 keV annihilation, 1.204 MeV double escape, 1.714 MeV single escape, and 2.223 MeV from hydrogen. The neutron spectra obtained on the BC-408 scintillator detectors included no peaks, and only the total fluence was used. The neutron spectrum incident on the detectors may be seen in FIG. 31.

SNM volumes ranged from 16-244 cm³. Increasing the amount of SNM present increased the view factor to each detector array and the amount of subcritical multiplication. This was found to not have a significant effect on predicting source location as much as detector binning combined with the gaussian broadening parameters used, specifically within HPGe detector arrays. This led to an increase in the variance and false predictions of the source location for all PGNAA photopeaks using HPGe detectors, but the source location prediction for the total counts using HPGe detectors was correct for most cases with variance considered. LaBr₃ detector arrays did not have this issue occur as the PGNAA photopeaks were well defined at all detectors. For this reason, source location predictions off HPGe PGNAA photopeaks were discarded. Both the HPGe and LaBr₃ detector arrays were not able to identify the correct source location of the SNM using the PGNAA photopeaks as the volume of SNM went above 185 cm³. This is shown in the Tables 8-12 and is due to the larger view factor between the SNM and the HPGe and LaBr₃ detector arrays, which the methodology doesn't account for. Channel error within the PGNAA photopeaks were less than 1% relative error. Each source location prediction was compared to the center of the SNM, which was (20, 0, 0) for the primary location.

TABLE 8
16 cm³ Source Locations using LaBr₃ Detector Arrays

| Photopeak | | | | | | distance |
|---|---|---|---|---|---|---|
| energy | X | Y | Z | r1 | Std | away |
| (MeV) | (cm) | (cm) | (cm) | (cm) | (cm²) | (cm) |
| | HEU | | | | | |
| 0.061 | 19.17 | −0.06 | 0.00 | 20.89 | 10.85 | 0.83 |
| 0.551 | 19.17 | −0.06 | 0.00 | 20.89 | 9.49 | 0.83 |
| 1.204 | 19.17 | −0.06 | 0.00 | 20.89 | 38.54 | 0.83 |
| 1.714 | 19.17 | −0.06 | 0.00 | 20.89 | 3.59 | 0.83 |
| 2.223 | N/A | N/A | N/A | N/A | N/A | N/A |
| Total | 19.17 | −0.06 | 0.00 | 20.89 | 6.89 | 0.83 |
| | WGPu | | | | | |
| 0.061 | 19.15 | −0.08 | −0.02 | 20.91 | 14.41 | 0.85 |
| 0.511 | 19.15 | −0.08 | 0.00 | 20.91 | 17.56 | 0.85 |
| 1.204 | 19.15 | −0.08 | 0.00 | 20.91 | 14.98 | 0.85 |
| 1.714 | 21.91 | −0.51 | −3.65 | 23.96 | 2.97 | 4.15 |
| 2.223 | 21.91 | −0.51 | −3.64 | 23.96 | 11.29 | 4.14 |
| Total | 21.40 | −0.47 | 0.00 | 23.17 | 6.44 | 1.48 |

TABLE 9
47 cm³ Source Locations using LaBr₃ Detector Arrays

| Photopeak | | | | | | distance |
|---|---|---|---|---|---|---|
| energy | X | Y | Z | r1 | Std | away |
| (MeV) | (cm) | (cm) | (cm) | (cm) | (cm²) | (cm) |
| | HEU | | | | | |
| 0.061 | 19.03 | −0.11 | 0.00 | 20.67 | 24.17 | 0.97 |
| 0.551 | 19.03 | −0.11 | 0.00 | 20.67 | 4.28 | 0.97 |
| 1.204 | 19.03 | −0.11 | 0.00 | 20.67 | 16.82 | 0.97 |
| 1.714 | N/A | N/A | N/A | N/A | N/A | N/A |
| 2.223 | N/A | N/A | N/A | N/A | N/A | N/A |
| Total | 19.03 | −0.11 | 0.00 | 20.67 | 10.14 | 0.97 |
| | WGPu | | | | | |
| 0.061 | 19.18 | −0.10 | −1.06 | 20.97 | 15.66 | 1.35 |
| 0.511 | 19.16 | −0.10 | −0.22 | 20.93 | 13.57 | 0.87 |
| 1.204 | 19.16 | −0.10 | −0.02 | 20.93 | 8.43 | 0.85 |
| 1.714 | 19.16 | −0.10 | 0.00 | 20.93 | 9.29 | 0.85 |
| 2.223 | 19.16 | −0.10 | 0.00 | 20.93 | 7.74 | 0.85 |
| Total | 19.15 | −0.10 | 0.00 | 20.90 | 6.42 | 0.86 |

TABLE 10
117 cm³ Source Locations using LaBr₃ Detector Arrays

| Photopeak | | | | | | distance |
|---|---|---|---|---|---|---|
| energy | X | Y | Z | r1 | Std | away |
| (MeV) | (cm) | (cm) | (cm) | (cm) | (cm²) | (cm) |
| | HEU | | | | | |
| 0.061 | 19.00 | −0.12 | 0.00 | 20.55 | 28.21 | 1.01 |
| 0.511 | 19.00 | −0.12 | 0.00 | 20.55 | 5.36 | 1.01 |
| 1.204 | 19.00 | −0.12 | 0.00 | 20.55 | 33.04 | 1.01 |
| 1.714 | 19.00 | −0.12 | 0.00 | 20.55 | 73.63 | 1.01 |
| 2.223 | 19.00 | −0.12 | 0.00 | 20.55 | 1.38 | 1.01 |
| Total | 19.00 | −0.12 | 0.00 | 20.55 | 10.04 | 1.01 |
| | WGPu | | | | | |
| 0.061 | 18.19 | −0.25 | 0.00 | 19.29 | 7.58 | 1.83 |
| 0.511 | 18.19 | −0.25 | 0.00 | 19.29 | 18.58 | 1.83 |
| 1.204 | 18.19 | −0.25 | 0.00 | 19.29 | 3.79 | 1.83 |
| 1.714 | 18.19 | −0.25 | 0.00 | 19.29 | 5.64 | 1.83 |
| 2.223 | 18.19 | −0.25 | 0.00 | 19.29 | 3.94 | 1.83 |
| Total | 18.19 | −0.25 | 0.00 | 19.29 | 4.28 | 1.83 |

TABLE 11
185 cm³ Source Locations using LaBr₃ Detector Arrays

| Photopeak | | | | | | distance |
|---|---|---|---|---|---|---|
| energy | X | Y | Z | r1 | Std | away |
| (MeV) | (cm) | (cm) | (cm) | (cm) | (cm²) | (cm) |
| | HEU | | | | | |
| 0.061 | 19.03 | −0.12 | 0.00 | 20.68 | 24.00 | 0.97 |
| 0.511 | 19.03 | −0.12 | 0.00 | 20.68 | 9.28 | 0.97 |
| 1.204 | 19.03 | −0.12 | 0.00 | 20.68 | 24.14 | 0.97 |
| 1.714 | 19.03 | −0.12 | 0.00 | 20.68 | 15.36 | 0.97 |
| 2.223 | 19.03 | −0.12 | 0.00 | 20.68 | 15.87 | 0.97 |
| Total | 19.03 | −0.12 | 0.00 | 20.68 | 8.16 | 0.97 |
| | WGPu | | | | | |
| 0.061 | 15.86 | −0.51 | 0.00 | 16.54 | 3.90 | 4.17 |
| 0.511 | 15.86 | −0.51 | 0.00 | 16.54 | 6.50 | 4.17 |
| 1.204 | 15.86 | −0.51 | 0.00 | 16.54 | 2.56 | 4.17 |
| 1.714 | 15.86 | −0.51 | 0.00 | 16.54 | 2.70 | 4.17 |
| 2.223 | 15.86 | −0.51 | 0.00 | 16.54 | 2.39 | 4.17 |
| Total | 15.86 | −0.51 | 0.00 | 16.54 | 2.63 | 4.17 |

TABLE 12
244 cm³ Source Locations using LaBr₃ Detector Arrays

| Photopeak | | | | | | distance |
|---|---|---|---|---|---|---|
| energy | X | Y | Z | r1 | Std | away |
| (MeV) | (cm) | (cm) | (cm) | (cm) | (cm²) | (cm) |
| | HEU | | | | | |
| 0.061 | 19.00 | −0.13 | −0.26 | 20.77 | 14.23 | 1.04 |
| 0.511 | 19.00 | −0.13 | −0.07 | 20.77 | 19.67 | 1.01 |
| 1.204 | 19.00 | −0.13 | −0.01 | 20.77 | 12.38 | 1.01 |
| 1.714 | 19.00 | −0.13 | 0.00 | 20.77 | 16.97 | 1.01 |
| 2.223 | 19.00 | −0.13 | 0.00 | 20.77 | 11.71 | 1.01 |
| Total | 18.94 | −0.13 | 0.00 | 20.66 | 6.89 | 1.07 |
| | WGPu | | | | | |
| 0.061 | 15.33 | −0.60 | 9.60 | 19.62 | 3.48 | 10.70 |
| 0.511 | 15.33 | −0.60 | 9.59 | 19.61 | 5.95 | 10.69 |
| 1.204 | 15.33 | −0.60 | 9.61 | 19.62 | 2.95 | 10.70 |
| 1.714 | 15.32 | −0.62 | 9.60 | 19.62 | 3.97 | 10.70 |
| 2.223 | 15.33 | −0.62 | 9.62 | 19.62 | 2.35 | 10.71 |
| Total | 17.10 | −0.29 | 10.95 | 21.82 | 2.67 | 11.33 |

The polyethylene being a scattering and attenuating medium for neutrons was found to not have a noticeable effect on source location predictions. This is seen in the comparison between the total counts from the HPGe, LaBr₃, and BC-408 detector arrays in Tables 13-17. The source location predictions done with total neutron counts using BC-408 scintillator detectors yielded better results than the total photon counts from HPGe and LaBr₃ detector arrays. This was contributed to more neutrons being produced from fission and subcritical multiplication than photons in different volumes of SNM, yielding better sampling. For the energy spectra of photons and neutrons produced from fission and subcritical multiplication, the average mean-free path for photons was smaller than the average mean-free path of neutrons within the polyethylene. The extra scattering and absorption of photons was expected to yield less accurate results than the neutrons produced. Photons scattering in the polyethylene at higher volumes of SNM hindered source prediction as well. The total number of counts in each spectrum is proportional to the amount of SNM present in the simulations and the type of SNM present. More counts were seen in the plutonium spectra compared to the uranium spectra due to subcritical multiplication. The error for each total count for photons and neutrons were less than 0.015% relative error.

TABLE 13
16 cm³ Source Locations using Total Detector Counts

| | | | | | | distance |
|---|---|---|---|---|---|---|
| | X | Y | Z | r1 | Std | away |
| Detector Type | (cm) | (cm) | (cm) | (cm) | (cm²) | (cm) |
| | HEU | | | | | |
| HPGe | 17.37 | −0.11 | 0.03 | 19.13 | 10.22 | 2.64 |
| LaBr₃ | 19.17 | −0.06 | 0.00 | 20.89 | 6.89 | 0.83 |
| BC-408 | 19.76 | 0.33 | 0.00 | 17.23 | 3.55 | 0.41 |
| | WGPu | | | | | |
| HPGe | 17.63 | 0.19 | 0.02 | 19.39 | 7.73 | 2.38 |
| LaBr₃ | 21.40 | −0.47 | 0.00 | 23.17 | 6.44 | 1.48 |
| BC-408 | 19.75 | 0.33 | 0.00 | 17.12 | 3.59 | 0.41 |

TABLE 14
47 cm³ Source Locations using Total Detector Counts

| | | | | | | distance |
|---|---|---|---|---|---|---|
| | X | Y | Z | r1 | Std | away |
| Detector Type | (cm) | (cm) | (cm) | (cm) | (cm²) | (cm) |
| | HEU | | | | | |
| HPGe | 16.93 | −0.28 | 0.00 | 18.68 | 23.59 | 3.09 |
| LaBr₃ | 19.03 | −0.11 | 0.00 | 20.67 | 10.14 | 0.97 |
| BC-408 | 19.77 | 0.33 | 0.00 | 17.43 | 3.48 | 0.41 |
| | WGPu | | | | | |
| HPGe | 17.20 | −0.09 | 0.00 | 18.95 | 8.72 | 2.81 |
| LaBr₃ | 21.40 | −0.47 | 0.00 | 23.17 | 6.44 | 1.48 |
| BC-408 | 19.76 | 0.33 | 0.00 | 17.43 | 3.48 | 0.41 |

TABLE 15
117 cm³ Source Locations using Total Detector Counts

| | | | | | | distance |
|---|---|---|---|---|---|---|
| | X | Y | Z | r1 | Std | away |
| Detector Type | (cm) | (cm) | (cm) | (cm) | (cm²) | (cm) |
| | HEU | | | | | |
| HPGe | 16.32 | −0.45 | 0.00 | 18.05 | 27.51 | 3.71 |
| LaBr₃ | 19.00 | −0.12 | 0.00 | 20.55 | 10.04 | 1.01 |
| BC-408 | 19.78 | 0.34 | 0.00 | 17.73 | 3.39 | 0.40 |
| | WGPu | | | | | |
| HPGe | 16.69 | −0.32 | 0.00 | 18.42 | 5.70 | 3.33 |
| LaBr₃ | 18.19 | −0.25 | 0.00 | 19.29 | 4.28 | 1.83 |
| BC-408 | 19.78 | 0.33 | 0.00 | 18.06 | 3.28 | 0.40 |

TABLE 16
185 cm³ Source Locations using Total Detector Counts

| | | | | | | distance |
|---|---|---|---|---|---|---|
| | X | Y | Z | r1 | Std | away |
| Detector Type | (cm) | (cm) | (cm) | (cm) | (cm²) | (cm) |
| | HEU | | | | | |
| HPGe | 16.05 | −0.53 | 0.00 | 17.77 | 12.51 | 3.99 |
| LaBr₃ | 19.03 | −0.12 | 0.00 | 20.68 | 8.16 | 0.97 |
| BC-408 | 19.79 | 0.34 | 0.00 | 17.87 | 3.34 | 0.40 |
| | WGPu | | | | | |
| HPGe | 16.64 | −0.31 | 0.00 | 18.38 | 3.66 | 3.37 |
| LaBr₃ | 15.86 | −0.51 | 0.00 | 16.54 | 2.63 | 4.17 |
| BC-408 | 19.77 | 0.34 | 0.00 | 18.76 | 3.08 | 0.40 |

TABLE 17
244 cm³ Source Locations using Total Detector Counts

| | | | | | | distance |
|---|---|---|---|---|---|---|
| | X | Y | Z | r1 | Std | away |
| Detector Type | (cm) | (cm) | (cm) | (cm) | (cm²) | (cm) |
| | HEU | | | | | |
| HPGe | 15.75 | −0.66 | 0.00 | 17.48 | 8.81 | 4.30 |
| LaBr₃ | 18.94 | −0.13 | 0.00 | 20.66 | 6.89 | 1.07 |
| BC-408 | 19.79 | 0.34 | 0.00 | 17.93 | 3.33 | 0.40 |
| | WGPu | | | | | |
| HPGe | 16.81 | −0.32 | 7.60 | 20.08 | 2.96 | 8.25 |
| LaBr₃ | 17.10 | −0.29 | 10.95 | 21.82 | 2.67 | 11.33 |
| BC-408 | 19.77 | 0.33 | 0.00 | 19.68 | 2.86 | 0.40 |

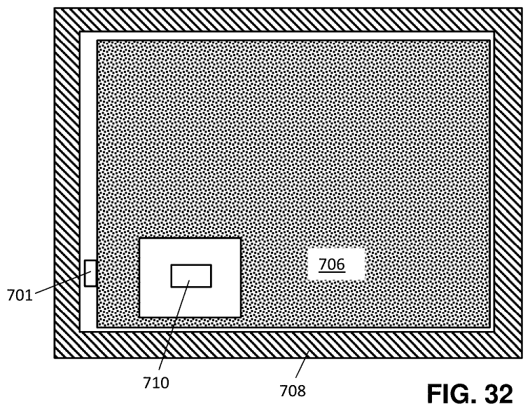

The SNM source 710 was moved to another location of the hollow polyethylene cube container 706 as seen in FIG. 32, and the simulations were ran again for source prediction using PGNAA photopeaks from HPGe and LaBr₃ detector arrays and total counts collected from HPGe, LaBr₃, and BC-408 detectors. The surrounding material 708 in FIG. 32 represents tungsten or air in keeping with FIGS. 28 and 29, respectively. The center of the SNM at the alternative location was (10, −9, −9). Results obtained were comparable to results discussed prior in the main geometry displayed in FIG. 28 and FIG. 29. Source location predictions from the secondary location using total counts from HPGe, LaBr₃, and BC-408 detectors are displayed in Table 11 for 16 cm³ of SNM. Source location predictions using PGNAA photopeaks from HPGe and LaBr₃ detector arrays for 16 cm³ of SNM are displayed in Table 19.

TABLE 18
16 cm³ Source Locations using Total
Detector Counts, Secondary Location

| | | | | | | distance |
|---|---|---|---|---|---|---|
| | X | Y | Z | r1 | Std | away |
| Detector Type | (cm) | (cm) | (cm) | (cm) | (cm²) | (cm) |
| | HEU | | | | | |
| HPGe | 11.67 | −2.52 | 0.00 | 13.67 | 8.39 | 11.22 |
| LaBr₃ | 9.89 | −3.99 | 0.00 | 12.32 | 7.56 | 10.30 |
| BC-408 | 13.05 | 0.94 | 0.00 | 6.45 | 17.16 | 13.75 |
| | WGPu | | | | | |
| HPGe | 12.64 | −1.49 | 0.00 | 13.87 | 8.39 | 12.01 |
| LaBr₃ | 10.89 | −3.11 | 0.00 | 12.76 | 7.72 | 10.79 |
| BC-408 | 13.19 | 0.83 | 0.00 | 7.69 | 22.76 | 13.70 |

TABLE 19
16 cm³ Source Locations using PGNAA photopeaks
from LaBr₃ Detector Arrays, Secondary Location

| Photopeak | | | | | | distance |
|---|---|---|---|---|---|---|
| energy | X | Y | Z | r1 | Std | away |
| (MeV) | (cm) | (cm) | (cm) | (cm) | (cm²) | (cm) |
| | HEU | | | | | |
| 0.061 | 1.06 | −11.81 | −10.51 | 16.06 | 11.41 | 9.49 |
| 0.511 | 1.06 | −11.81 | −10.51 | 16.06 | 16.99 | 9.49 |
| 1.204 | 1.06 | −11.81 | −10.51 | 16.06 | 14.11 | 9.49 |
| 1.714 | 1.06 | −11.81 | −10.51 | 16.06 | 5.81 | 9.49 |
| 2.223 | 1.07 | −11.81 | −10.51 | 16.06 | 6.55 | 9.49 |
| Total | 9.89 | −3.99 | 0.00 | 12.32 | 7.56 | 10.30 |
| | WGPu | | | | | |
| 0.061 | 9.92 | −3.61 | 0.00 | 9.11 | 9.00 | 10.49 |
| 0.511 | 9.92 | −3.61 | 0.00 | 9.11 | 7.74 | 10.49 |
| 1.204 | 9.92 | −3.61 | 0.00 | 9.11 | 5.67 | 10.49 |
| 1.714 | 16.19 | −2.83 | 0.00 | 17.76 | 3.35 | 12.54 |
| 2.223 | 16.19 | −2.83 | 0.00 | 17.76 | 5.65 | 12.54 |
| Total | 10.89 | −3.11 | 0.00 | 12.76 | 7.72 | 10.79 |

The alternative location of the SNM within the package was not able to be predicted correctly with the methodology used. This was due to the change in view factor between each of the four detectors and the SNM. The first source location centered at (20, 0, 0) was more centered in the package and had relatively the same amount of polyethylene around the SNM. The second source location centered at (10, −9, −9) was in the corner of the package. This change in location affected the source location results by having uneven amounts of polyethylene between each detector and the SNM, and the view factor from each detector to the SNM. This justifies the over prediction of the secondary location due to scattering and absorption of neutrons and photons as particles traveled to the top and right detector seen in FIG. 28 and FIG. 29. Scattering and absorption within the polyethylene increased the variance and standard deviation of the detector responses for location two compared to location one.

The methodology used in these descriptions was intended for gamma point source identification using point detectors to yield a standard deviation of zero; as the size of the source, detectors, or view factor between the two increases, so does the standard deviation of the source location. It was found that a weak scattering and absorbing medium may be used if it is uniform throughout the geometry, such as in the polyethylene package. It was observed that strong scattering and absorbing mediums using this method were found to over predict the location of the source. Difference in view factor between the source and each detector increases the standard deviation of the source location prediction. To increase the accuracy of the results for each SNM location, the detector size can be minimized and the distance between the package and each detector can be increased.

This would make the detectors used better resemble point detectors used in the source location methodology. Increasing the number of detectors would decrease the standard deviation of the source prediction and yield better results by increasing the maximum detector combinations factorially. Neutrons were found to work for the source localization as well with this methodology using nTOF to produce neutron energy spectra; since only the total neutron count was used in this work, ³He proportional counters may have been used in supplement. If peaks within the neutron spectra were to be identified, nTOF would have been advantageous. Peak identification using nTOF or PGNAA may allow for identification of multiple sources with unique energy signatures, such as a package containing ¹³⁷Cs and ⁶⁰Co, multiple neutron sources, or a combination of both neutron and gamma sources. Neutron source identification becomes improbable if the neutron source is hidden within a neutron scattering material with the material composition and thickness being unknown. With a 1 Ci ²⁴¹Am source activity it was determined that 1630 seconds were needed to obtain the results for each detector system with the quasi-forward directional AmBe source. Coupling source and material identification together would increase acquisition time but would only require one system to determine.

The location of the SNM was able to be correctly identified using photopeaks from LaBr₃ detector arrays and the total counts incident on LaBr₃, HPGe, and BC-408 detectors for locations near the center of the polyethylene package. The volume and gaussian broadening parameters used on the photon spectra was found to play a significant role in determining the correct source location of the SNM. In this parametric approach, source predictions for PGNAA detectors started to degrade after 185 cm³ of SNM. The source predictions from the total neutron count incident on BC-408 scintillator detectors was found to be unaffected as the volume of SNM increased. As the location of the SNM was changed to the secondary location, this changed the view factor between the SNM and each detector. The amount of polyethylene scattering and absorbing photons and neutrons between the SNM and each detector changed significantly. The combination of these two factors lead to the methodology over predicting the location of the SNM at the secondary location, as it does not account for either of them. This led to higher variances and standard deviations of detector responses for the second location of the SNM. The methods described herein are valid for identifying relative source location. Results may be improved by reducing the size of each detector and increasing the distance between each detector and the package. The results demonstrate that a forward biased neutron source is an advantageous choice for source location using PGNAA and neutrons from fission, as the neutrons are forward emitting and contain high energies.

MCNP 6.1.1 EXAMLE INPUT DECK

Parametric studies for Source Location
c Modeled off actual dimensions and materials, includes neutron energies
c For troubleshooting

| | |
|---|---|
| c | = cell cards = |

c

| | |
|---|---|
| c 1 | 8 −13.52 1 −2 3 −4 5 −6 imp:p=1 imp:n=1 $ americium |
| c 2 | 10 −19.32 2 −7 3 −4 5 −6 imp:p=1 imp:n=1 $ gold coating |

imp:p=1 imp:n=1
c
c detector array sides

| | |
|---|---|
| 30 | 24 −1.023 −120 121 −122 123 100 −105 imp:p=1 imp:n=1 $ Detector radius for array |
| 40 | 24 −1.023 −120 121 −122 123 103 −104 imp:p=1 imp:n=1 $ Detector radius for array forward |

c

| | |
|---|---|
| 36 | 12 −0.001225 100 −105 −107 109 −42 43 #30 imp:p=1 imp:n=1 $ back detectors area around |
| 37 | 12 −0.001225 103 −104 −107 109 −42 43 #40 imp:p=1 imp:n=1 $ forward detectors area around |

c
c detector array top and bottom

| | |
|---|---|
| 50 | 24 −1.023 130 −131 −132 133 106 −107 imp:p=1 imp:n=1 $ Detector radius for array top |
| 60 | 24 −1.023 140 −141 −142 143 109 −108 imp:p=1 imp:n=1 $ Detector radius for array bottom |

c

| | |
|---|---|
| 56 | 12 −0.001225 105 106 −107 −103 −42 43 #50 imp:p=1 imp:n=1 $ top detectors area around |
| 57 | 12 −0.001225 105 −108 109 −103 −42 43 #60 imp:p=1 imp:n=1 $ bottom detectors area around |

| | |
|---|---|
| c | = surface cards = |

c
c Americium source
c

| | |
|---|---|
| c | $ use surface 320 if placing Am241 source in hot cell |

| 1 | px 0.0 | |
|---|---|---|
| 2 | px 0.000000485 | $ top surface of Am241 source |

| | | |
|---|---|---|
| 3 | pz −10 | $ left surface of Am241 source |
| 4 | pz −8 | $ right surface of Am241 source |
| 5 | py −10 | $ forward surface of Am241 source |

| | | |
|---|---|---|
| 7 | px 0.000200485 | $ gold coating |

| | | |
|---|---|---|
| 8 | px −0.02 | $ silver backing |

c
c Target foil
c

| | | |
|---|---|---|
| 9 | px 0.002700485 | $ top of target foil |
| 10 | pz −10.25 | $ left surface of target |

| | | |
|---|---|---|
| 11 | pz −7.75 | $ right surface of target |

| | | |
|---|---|---|
| 32 | py targetybottom | $ forward surface of |
| | | neutron target 1 |
| 33 | py targetytop | $ back surface of neutron target 1 |

| 100 | px −3.04 | $ detector1 backing |
|---|---|---|
| 101 | px 4.04 | |
| 102 | cx 1.27 | $ detector radia 1+2 |

| | |
|---|---|
| c | = data cards = |

c

| | | |
|---|---|---|
| m8 | 95241 1.0 | $ Americium |

| | | |
|---|---|---|
| m9 | 4009 1.0 | $Beryllium |
| m10 | 79197 1.0 | $Gold |

| m11 | 47107 0.51839 47109 0.48161 | $ Silver |
|---|---|---|
| m12 | 6012 0.000150 7014 0.784431 8016 0.210748 $ 18040 0.004671 $ Air | |
| m13 | 57139 1 35081 3 | $ LaBr₃ |
| m14 | 11023 1 | $ Na target |
| m15 | 79197 1 | $ Au target |
| m16 | 94239 −0.93 94238 −0.07 | $ High enriched Pu target |
| m17 | 1001 1 | $ H target |
| m18 | 92235 −0.93 92238 −0.07 | $ High enriched U target |
| m19 | 74000 −0.9 28000 −0.05 26056 −0.05 | $ Tungsten |
| m20 | 6012 2 1001 4 | $ polyethyline |
| m24 | 6012 1.0 1001 1.104 | $ BC-408 |

mode n p
sdef cel=14 ERG=D203 par=n &

X=d200 Y=d201 Z= −9 pos=10 −9 −9 $ 241Am neutron source

SI200 18.0 22.0
SP200 0 1
SI201 targetybottom targetytop
SP201 0 1
SI202 targetzbottom targetztop
SP202 0 1
SI203 L 0.0048828 4093I 10
nps 100000000
f38:n 14 $ front detector array

| | |
|---|---|
| E38 0.0 79I 10.0 | $ binning chosen for MCA in real life |

f58:n 40 $ front detector array

| | |
|---|---|
| E58 0.0 79I 10.0 | $ binning chosen for MCA in real life |

f48:n 30 $ rear detector array

| | |
|---|---|
| E48 0.0 79I 10.0 | $ binning chosen for MCA in real life |

f68:n 50 $ top detector array

| | |
|---|---|
| E68 0.0 79I 10.0 | $ binning chosen for MCA in real life |

f78:n 60 $ bottom detector array

| | |
|---|---|
| E78 0.0 79I 10.0 | $ binning chosen for MCA in real life |

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A system for detecting gamma radiation by neutron activation of a material, the system comprising:
a switchable radiation source comprising:
a primary source assembly comprising an alpha particle emitter; and
a target assembly in which, upon irradiation of the target assembly by alpha particles from the primary source assembly, secondary radiation comprising neutrons is produced;
wherein an alignment, proximity or exposure of the primary source assembly relative to the target assembly is adjustable to control irradiation of the target assembly by the primary source assembly and thereby selectively irradiate a material under interrogation with the secondary radiation; and
at least a first detector configured to detect gamma radiation prompted by neutron activation of the material under interrogation.

2. The system of claim 1, wherein the target assembly comprises a stable isotope and irradiation of the target assembly by alpha particles from the primary source assembly creates compound nuclei and neutrons.

3. The system of claim 1, wherein:
the primary source assembly comprises at least one planar source tile;
the target assembly comprises at least one planar target tile; and
alignment or proximity of the source tile and target tile is adjustable by movement of the source tile or target tile.

4. The system of claim 1, further comprising a shielding shell that is movable by rotation or translation between the primary source assembly and target assembly.

5. The system of claim 1, wherein the target assembly comprises a circular arrangement of multiple target panels, and the primary source assembly comprises a source panel relative to which the circular arrangement of multiple target panels is rotatable.

6. The system of claim 1, wherein the first detector comprises a high purity germanium detector.

7. The system of claim 1, wherein the first detector comprises a lanthanum-bromide detector.

8. The system of claim 1, wherein the first detector comprises a plastic scintillator.

9. The system of claim 1, further comprising shielding material partially surrounding the first detector.

10. The system of claim 1, wherein the material under interrogation is positioned in a container, and wherein the switchable radiation source device is positioned outside of the container.

11. The system of claim 10, wherein the first detector is configured to detect the gamma radiation through the container.

12. The system of claim 11, further comprising a second detector configured to detect gamma radiation prompted by neutron activation of the material under interrogation through the container.

13. The system of claim 12, wherein the system is configured to determine a location of the material under interrogation based on signals from the first detector and second detector.

14. The system of claim 1, wherein the alpha particle emitter comprises americium-241, and the target assembly comprises beryllium.

15. A method for detecting gamma radiation by neutron activation of a material, the method comprising:
irradiating a target assembly with alpha particles from a primary source assembly, thereby producing secondary radiation comprising neutrons;
irradiating a material under interrogation with the secondary radiation; and
detecting gamma radiation prompted by neutron activation of the material under interrogation,
wherein irradiating the target assembly with alpha particles from the primary source assembly comprises controlling a switchable radiation source in which an alignment, proximity or exposure of the primary source assembly relative to the target assembly is adjustable to control irradiation of the target assembly by the alpha emitter and thereby selectively irradiate a material under interrogation with the secondary radiation.

16. The method of claim 15, wherein:
the primary source assembly comprises at least one planar source tile;
the target assembly comprises at least one planar target tile; and
controlling the switchable radiation source comprises adjusting alignment or proximity of the source tile and target tile by movement of the source tile or target tile.

18. The method of claim 15, wherein controlling the switchable radiation source comprises moving a shielding shell by rotation or translation between the primary source assembly and target assembly.

19. The method of claim 15, wherein:
the target assembly comprises a circular arrangement of multiple target panels;
the primary source assembly comprises a source panel relative to which the circular arrangement of multiple target panels is rotatable; and
controlling the switchable radiation source comprises selecting an angular position of the target assembly relative to the primary source assembly.

20. The method of claim 15, wherein the material under interrogation is positioned in a container, and wherein the switchable radiation source device is positioned outside of the container.
